(19) United States
(12) Patent Application Publication
(10) Pub. No.: US 2015/0248534 A1
(43) Pub. Date: Sep. 3, 2015

(54) System And Method Of Generating A User Interface Display Of Patient Parameter Data

(71) Applicant: DRAEGER MEDICAL SYSTEMS, INC., Andover, MA (US)

(72) Inventors: Bruce Alan Krzywicki, Westford, MA (US); Kathleen Datta, Arlington, MA (US); Tatyana Goryacheva, Moscow (RU); Andrew P. Levy, Charlestown, MA (US); Andreas Beier, Haverhill, MA (US); Roman Ernesto Pichardo, Woburn, MA (US)

(73) Assignee: Draeger Medical Systems, Inc., Andover, MA (US)

(21) Appl. No.: 14/429,333

(22) PCT Filed: Sep. 18, 2013
(86) PCT No.: PCT/US2013/060392

§ 371 Date: Mar. 18, 2015

Related U.S. Application Data
(60) Provisional application No. 61/702,542, filed on Sep. 18, 2012.

(51) Int. Cl. G06F 19/00; G06F 3/0484; G06F 3/0482

(52) U.S. Cl. CPC G06F 19/3406; G06F 3/0482; G06F 3/04842; G06F 3/04847

(57) ABSTRACT

A method and apparatus that displays at least one user interface display image including patient parameter data is provided. An acquisition processor selectively acquires, from a storage repository, at least one type of patient medical parameter data associated with at least one patient acquired over a period of time. A display processor generates a display including at least one display image representing at least a portion of the acquired patient medical parameter data and a navigation bar associated with the at least one display image including a user selectable window identifying a range of acquired patient medical parameter data to be displayed within the display image. A controller is electrically coupled to the acquisition processor and the display processor. The controller controls navigating through the patient medical parameter data and adjustment of the user selectable window, and causes the display processor to modify the generated at least one display image.

### CROSS-REFERENCE TO RELATED APPLICATIONS

This application claims priority from U.S. Provisional Application Ser. No. 61/702,542 filed on Sep. 18, 2012 by Bruce Alan Krzywicki et al.

### FIELD OF THE INVENTION

This invention concerns a system and method for processing and displaying patient parameter data, and more specifically to improving the visual representation and navigation of the patient parameter data.

### BACKGROUND OF THE INVENTION

In the course of providing healthcare to patients, it is necessary to monitor vital statistics and other patient parameters. Patient medical parameter data may be acquired, collated, stored and displayed for use in providing clinical care in hospitals, clinics, and other healthcare delivery settings. Patient medical parameter data may include any data acquired from a patient by a patient monitoring device via patient connected sensors (e.g. electrocardiogram (ECG) monitor, electroencephalograph (EEG) monitor, etc.). Patient medical parameter data may also include patient vital sign data, ventilator data, infusion pump data associated with fluid delivery and any other data associated with the provision of healthcare to a patient. The patient medical parameter data is typically displayed on a patient monitoring device located at a patient bedside or at a central monitoring station that aggregates and displays patient medical parameter data at a central location enabling one or more clinicians to simultaneously monitor a plurality of different patient. It is therefore desirable to provide a system and method for displaying the acquired patient parameter data in an efficient manner while enabling a clinician to quickly and easily navigate the acquired patient parameter data. A system according to invention principles addresses deficiencies of known systems for displaying patient parameter data.

### SUMMARY OF THE INVENTION

In a one embodiment, an apparatus that displays at least one user interface display image including patient parameter data is provided. An acquisition processor selectively acquires, from a storage repository, at least one type of patient medical parameter data associated with at least one patient acquired over a period of time. A display processor generates a display including at least one display image representing at least a portion of the acquired patient medical parameter data and a navigation bar associated with the at least one display image including a user selectable window identifying a range of acquired patient medical parameter data to be displayed within the display image, the user selectable window being linked with the at least one display image. A controller is electrically coupled to the acquisition processor and the display processor. The controller controls navigating through the patient medical parameter data and adjustment of the user selectable window, and causes the display processor to modify the generated at least one display image.

In another embodiment, a method of generating at least one user interface display image including patient parameter data is provided. The method includes acquiring from a storage repository, via an acquisition processor, at least one type of patient medical parameter data associated with at least one patient acquired over a period of time. A display is generated via a display processor, the display including at least one display image representing at least a portion of the acquired patient medical parameter data and a navigation bar associated with the at least one display image including a user selectable window identifying a range of acquired patient medical parameter data to be displayed within the display image, the user selectable window being linked with the at least one display image. A controller controls navigating through the patient medical parameter data and adjusting the user selectable window, and causes the display processor to modify the generated at least one display image.

In a further one embodiment, an apparatus and method that displays at least one user interface display image including patient parameter data is provided. An acquisition processor selectively acquires, from a storage repository, at least one type of patient medical parameter data associated with at least one patient acquired over a period of time. A display processor generates a display using formatting data identifying types of patient medical parameter data to be displayed and an order for displaying the types of patient medical parameter data. The formatting data is derived from at least one of (a) a particular patient monitoring device and (b) the apparatus. The display includes at least one display image representing at least a portion of the acquired patient medical parameter data and a navigation bar associated with the at least one display image including a user selectable window identifying a range of acquired patient medical parameter data to be displayed within the display image, the user selectable window being linked with the at least one display image. A controller is electrically coupled to the acquisition processor and the display processor. The controller controls navigating through the patient medical parameter data and adjustment of the user selectable window, and causes the display processor to modify the generated at least one display image.

In yet another embodiment, an apparatus and method that displays at least one user interface display image including patient parameter data is provided. An acquisition processor selectively acquires, from a storage repository, at least one type of patient medical parameter data associated with at least one patient acquired over a period of time. A display processor generates a display including at least one display image representing at least a portion of the acquired patient medical parameter data and a navigation bar associated with the at least one display image including a user selectable window identifying a range of acquired patient medical parameter data to be displayed within the display image, the user selectable window being linked with the at least one display image, the at least one display image includes a plurality of data fields each corresponding to an interval of the range acquired patient medical parameter data identified by the user selectable window. A controller is electrically coupled to the acquisition processor and the display processor. The controller controls navigating through the patient medical parameter data and adjustment of the user selectable window, and causes the display processor to modify the generated at least one display image, the controller determines, from the range of acquired patient medical parameter data, whether a clinically significant event has occurred at a time between a current interval and a previous interval, and causes the display processor to generate an event indicator for display in the current interval data field with a current patient medical parameter value in response to the determination.

Another embodiment provides an apparatus and that displays at least one user interface display image including patient parameter data. An acquisition processor selectively acquires, from a storage repository, at least one type of patient medical parameter data associated with at least one patient acquired over a period of time. A display processor generates a display including at least one display image representing at least a portion of the acquired patient medical parameter data and a navigation bar associated with the at least one display image including a user selectable window identifying a range of acquired patient medical parameter data to be displayed within the display image, the user selectable window being linked with the at least one display image. The display processor generates a cursor image element enabling user selection of at least one sample of the acquired patient medical parameter data displayed in the at least one display window, the cursor image element being associated with one of (a) a selected position within the at least one display image; and (b) a selected data sample of the acquired patient medical parameter data. The display processor automatically at least one of (a) modifies at least one boundary of the cursor image element associated with a selected position in the at least one display image to be visually distinct indicating the acquired patient medical parameter data selected by the cursor image element will change upon acquisition of additional patient medical parameter data and (b) causes the cursor image element associated with the selected data sample to move with the selected data sample within the at least one display image upon acquisition of additional patient medical parameter data. A controller is electrically coupled to the acquisition processor and the display processor. The controller controls navigating through the patient medical parameter data and adjustment of the user selectable window, and causes the display processor to modify the generated at least one display image.

### BRIEF DESCRIPTION OF THE DRAWINGS

FIG. 1 is a block diagram of the system according to invention principles;

FIGS. 2-26 are exemplary screenshots of various user interface displays generated by the system according to invention principles; and

FIG. 27 is a flow diagram detailing the operation of the system according to invention principles.

### DETAILED DESCRIPTION

A system that generates a graphical user interface display including a plurality of user selectable image elements enabling efficient navigation and display of patient medical parameter data is provided. The system includes a central monitoring device that selectively acquires patient medical parameter data associated with at least one patient that has been or is currently being monitored by at least one type of patient connected monitoring device (e.g. ECG monitors, EEG monitors, ventilators, etc.). The system may advantageously acquire the patient medical parameter data from a patient medical parameter database that stores the sensed patient parameter data and enables efficient navigation and display on a display screen coupled to the central monitoring device. Efficient navigation of patient medical parameter data may be accomplished by generation of a user selectable image element representing a navigation bar which allows the user to selectively navigate a particular set of patient medical parameter data over a period of time while simultaneously providing information about the set of data being navigated. The navigation bar may include a first visual band representing a predetermined time range of patient medical parameter data that has been acquired and is stored in a medical parameter database. The time range may be selected by the user and, the display of the navigation bar image element is automatically modified to conform to the user selected time range. The first visual band may be represented in different colors and/or patterns to identify whether or not data at different points in the user selected time range is present. A selectively movable second visual band may be an image element associated with a particular predetermined time period within the set of patient medical parameter data that is currently being displayed within a data display window. The second visual band image element may extend between the first visual band and the data display window that is positioned above the first visual band and which displays the patient medical parameter data thereby linking the first visual band with the data display window easily informing the user that the data being displayed in the data display window represents data obtained during the particular window of time identified by the second visual band. The navigation bar may also include an event indicator representing a clinically significant event associated with the particular patient. Exemplary clinically significant events may include Asystole, Ventricular fibrillation, Ventricular tachycardia (VTACH), Ventricular run, accelerated idioventricular, Ventricular bigeminy, ST deviation of lead, a Parameter Limits threshold being reached, a user input manual event (e.g. administration of medication), Apnea, Tachycardia, Bradycardia, Supraventricular Tachycardia, Artifact, and/or atrial fibrillation. This listing of events that may be associated with the event indicator is described for purpose of example only and, in practice, any event providing any information associated with the patient may be generated and be represented by the event indicator in the navigation bar. Additionally, the manner in which the event indicator is displayed in the navigational bar may be event-specific advantageously enabling the clinician or user to quickly and visibly discern different types of events. For example, a first type of event may be displayed in a first manner (e.g. a first color) and a second different type of event may be displayed in a second manner (e.g. a second color different from the first color). This may allow the clinician's attention to be drawn to one event prior to another, for example, based on severity of the event or priority of an intervention that need be performed on a patient based on the type of event. Moreover, the user may view patient medical parameter display data associated with the event via a user input device (e.g. mouse, stylus, touch screen interface) by selecting a portion of the navigation bar image element proximate the event indicator. The system advantageously and automatically detects any selection within the navigation bar and proximate to any event indicator and determines that the clinician wishes to view patient medical parameter data related to the event. In response to this determination, the system automatically repositions the first indicator around the event indicator such that the event is centered in a time represented by the second visual band and displaying, in the data display window, the patient medical parameter data associated with the event as well as data acquired at a predetermined amount of time prior and subsequent to the event. This advantageous “snap-to” navigation enables clinicians to quickly access event specific patient medical parameter data without having to precisely center a selection image element (e.g. a cursor) on the event indicator. This is particularly advantageous when there is a significant amount of patient medical parameter data represented in the navigation bar resulting in an event indicator that may be difficult to precisely select using a user input/output device.

In response to positioning the second visual band within the navigation bar and displaying patient medical parameter data for the selected time period in the display window, the system further advantageously provides the ability to navigate among individual data samples within the selected time period. Navigation among data samples within the selected time period may be accomplished via generation of a selectively positionable cursor image element within the data display window, the appearance of which may be automatically modified based on the position of the cursor relative to time. A user may selectively position the cursor over at least one data sample being displayed in the data display window and the manner in which the cursor is being displayed may change depending on the time associated with the individual data sample. If the selected data sample is the most recently acquired data sample, a first portion of the cursor image element at a current point in time will be displayed differently from the remaining portion(s) of the cursor associated with earlier points in time. By displaying a portion of the cursor at the current time differently than the other portions, the system advantageously provides the user with a visual indication that the data being displayed will change upon each incremental update of data within the database and a new data sample will be highlighted or selected by the cursor after the next database update. The position of the cursor within the data display window may not change thereby resulting in the data sample selected by the cursor changing in response to update of the database and acquisition of later acquired patient medical parameter data. If the selected data sample is the data sample at the earliest time, a first portion of the cursor image element at an earliest point in time may be displayed differently from the remaining portion(s) of the cursor that are associated with later points in time. By displaying a portion of the cursor at the earliest time differently than the other portions, the system advantageously provides the user with a visual indication that the data being displayed will change upon each incremental update of data within the database and the particularly identified data sample will be lost after next update of data. If the cursor selects or highlights a data sample other than the earliest or latest data sample displayed in the data display window, each portion of the cursor may be displayed uniformly indicating that the data sample will not change for a period of time. In another embodiment, the cursor element may float such that, in response to selection of a particular data sample, the cursor will be anchored to the selected particular data sample. In this embodiment, the visual representation of the cursor may change as above depending on where the selected particular data sample is in time. If the selected particular data sample is the most recent data sample, the first portion will be displayed differently than the remaining portions of the cursor. Once updated and new data samples are displayed, the cursor may float with the selected particular data sample and the visual display thereof may change to be uniform thereby indicating that no new data may be forthcoming. The cursor may float as the selected particular data sample travels through the predetermined time period indicated by the second visual band and a portion of the cursor will once again change when the data sample is at the earliest point of the predetermined time period displayed indicating that the data sample will be lost at the next update of the database.

In a further embodiment, patient medical parameter data present within the portion of time selected by the second visual band may be displayed in a tabular trend display that provides information about the patient. In the tabular trend display, the system automatically updates a column of data representing a current time period with information about any events that occurred at time period between the current time period and a previous time period. Thus, data representing a clinically significant event is provided to a clinician viewing the tabular display at a point where the clinician is most likely to look (e.g. current time period data). By providing an indication of a previously occurring clinically significant event at a current time period, the event information is immediately brought to the attention of the clinician thereby enabling a quicker response thereto without the need for the clinician to scroll back through columns of data to find when the event has occurred.

In another embodiment, the patient medical parameter data present within the portion of time selected by the second visual band may be displayed in a graphical trend display that provides information about the patient in the form of a graphical trend. In the graphical trend, the patient parameter data being displayed advantageously enables the clinician to view any clinically significant events that may have occurred over the selected time period.

In either a tabular trend display image or a graphical trend display image, the system advantageously employs a common formatting parameter that selectively defines the type of patient parameters being displayed as well as the order in which these types of patient parameters are to be displayed. The common formatting parameter may be a first formatting parameter associated with a particular patient monitoring device from which the patient parameter data is acquired or a second formatting parameter associated with a central monitoring device. Should the second formatting parameter be implemented, the format of the patient parameter data as determined by the particular patient monitoring device will be overridden and all patient parameter data will be displayed in the same manner using the common second formatting parameter. Where the common formatting parameter is the second formatting parameter, a clinician may selectively configure all aspects used in producing the common formatting parameter. For example, the clinician may selectively choose from a set of available patient parameters for inclusion in the second formatting parameter as well as an order in which the selected patient parameters are to be displayed. During a setup mode, the clinician can advantageously select which of the first and second formatting parameters are to be used at a given time. Selection of the first formatting parameter results in the format of respective patient monitoring devices to be mirrored at the central monitoring device whereas selection of the second formatting parameter results in the format selected by the clinician to be displayed at the central monitoring device.

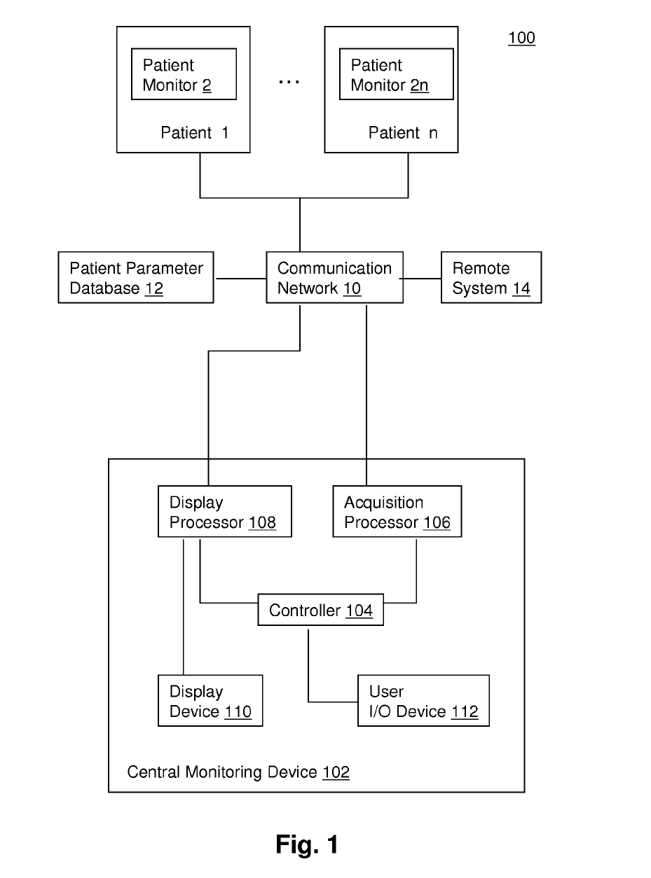

FIG. 1 is a block diagram of an embodiment of a system 100 according to invention principles. The system 100 may include at least one central monitoring device 102 coupled to receive patient medical parameter data associated with at least one patient 1 having at least one patient monitoring device 2 coupled thereto and able to sense data representing at least one type of patient parameter from the patient 1. FIG. 1 depicts the system including Patient 1-Patient n each having at least one patient monitoring device 2-2n connected to the respective patient for sensing at least one type of patient parameter from the respective patient. The patient monitoring devices 2-2n may be connected to a patient parameter database 12 via a communication network 10 enabling bidirectional communication therebetween. Data representing the at least one type of patient parameter may be communicated via communication network 10 and stored in the patient parameter database 12. In another embodiment, the patient parameter database 12 may be included within the central monitoring device 102. In a further embodiment, the system 100 may obtain patient medical parameter data from a plurality of different patient parameter databases that may be one of included within the central monitoring device 102, remotely accessible via the communication network 10 or any combination thereof. Each patient may have a unique record in the patient parameter database and the at least one type of patient parameter data sensed and monitored by the patient monitoring device may be stored in the record associated with the respective patient. The central monitoring device 102 may also automatically acquire at least one of patient medical parameter data and formatting data from any of the patient monitoring devices 2-n in real-time. The formatting data may include information used in generating a display image on the central monitoring device. The formatting data may include information identifying at least one type of patient medical parameter data at least one of (a) being monitored and (b) able to be monitored. Formatting data may also include information describing at least one of (a) an order of display for the at least one type of patient medical parameter data and (b) a position within a display image at which the at least one type of patient medical parameter data is to be displayed. The formatting data may also be communicated to and stored in a record of the patient parameter database 12. In this instance, the formatting data stored in the record of the patient parameter database 12 represents the formatting employed by the particular patient monitoring device that has generated the patient medical parameter data. The formatting data stored in the patient parameter database may be used to generate a display image on the central monitoring device. The communication network 10 may be a bidirectional communication network enabling bidirectional communication between any device and/or system connected thereto. The communication network may be formed from any of a local area network, wide area network and devices and/or systems may be able to connect to communication network 10 using wired communication protocols, wireless communication protocols or a combination thereof.

The central monitoring device 102 may be any apparatus or specific purpose computing system that enables at least one healthcare provider to selectively view and monitor patient medical parameter data associated with at least one patient. In one embodiment, the central monitoring device 102 may be a monitoring station located within a care unit of a healthcare facility whereby multiple patients are being treated for various medical ailments. A healthcare facility may include any of a hospital, a clinic or any other facility where patients may receive medical attention and care. In another embodiment, the central monitoring device 102 may be a computer system 14 located remotely from a healthcare facility that enables an individual medical professional to monitor patient. For example, the central monitoring device 102 may be located at a doctor's office enabling the doctor to view and monitor patient medical parameter data associated with patients located at a healthcare facility.

The central monitoring device may include a controller 104 for controlling operation thereof. The controller 104 is electrically coupled to an acquisition processor 106 that acquires patient medical parameter data from one of a patient monitoring device 2 and patient parameter database 12. The acquisition processor 106 may also acquire formatting data from at least one of the patient monitoring device 2 and the patient parameter database 12. The controller 104 is also connected to a display processor 108 that generates a user interface display image for display of acquired data including at least a portion of the acquired patient medical parameter data. The display processor 108 may generate a user interface display image using the formatting data acquired from the at least one of the patient monitoring device 2 and patient parameter database 12. The display processor 108 may also generate central monitoring device-specific formatting data independently from any formatting data acquired by the acquisition processor 106. In this instance, the display processor 108 may use the central monitoring device-specific formatting data to generate the user interface display image. A display device 110 is electrically coupled to the display processor 108 and enables display of the user interface display image thereon. As shown herein, the display device 110 is part of the central monitoring device 102. In one embodiment, the display device may be a mobile computing device such as a smartphone or a tablet computer such that the clinician may be able to view patient medical parameter data while being mobile around a care unit or if the clinician is remotely located from the patient. However, this is shown for purpose of example only and any display device may be selectively connectable to the central monitoring device 102 either directly or indirectly via communication network 10. The display processor 108 further generates user selectable image elements enabling navigation of at least a portion of the acquired patient medical parameter data. The display processor 108 may also generate indicators positioned within the navigation image elements that provide additional information about the acquired patient medical parameter data. The display processor 108 may also generate user selectable and positionable image elements representing a cursor that may be positioned over a section of the patient medical parameter data being displayed and provide additional information about the section of the patient medical parameter data. The display processor 108 may also generate a tabular display image representative of the acquired patient medical parameter data. The display processor 108 may generate an event indicator providing information associated with one of the patient and the patient medical parameter data in a tabular column representing a current time period wherein the event indicator may reference an event that occurred in a time period between the previous time period and current time period.

The central monitoring device 102 also includes a user input/output (I/O) device 112 that allows the user to selectively interact with and control the operation of the central monitoring device 102. Controlling the operation of the central monitoring device 102 may include one of directing acquisition of patient medical parameter data for one or more patients over a predetermined time period. Controlling operation may further encompass navigating among the acquired patient medical parameter data using one of the navigation image elements or cursors generated by the display processor. In another embodiment, the user I/O device enables the user to selectively determine and/or modify settings associated with generation of the user interface display image. Exemplary user I/O devices 112 may include at least one of (a) a mouse; (b) keyboard; (c) stylus; (d) touch screen; (d) an application resident on a smartphone or tablet; and (e) voice recognition module able to translate voice commands issued by a user. The user I/O devices 112 are describe for purposes of example only and any type of device that allows the user to selectively interact with and control the operation of the central monitoring device 102 may be used.

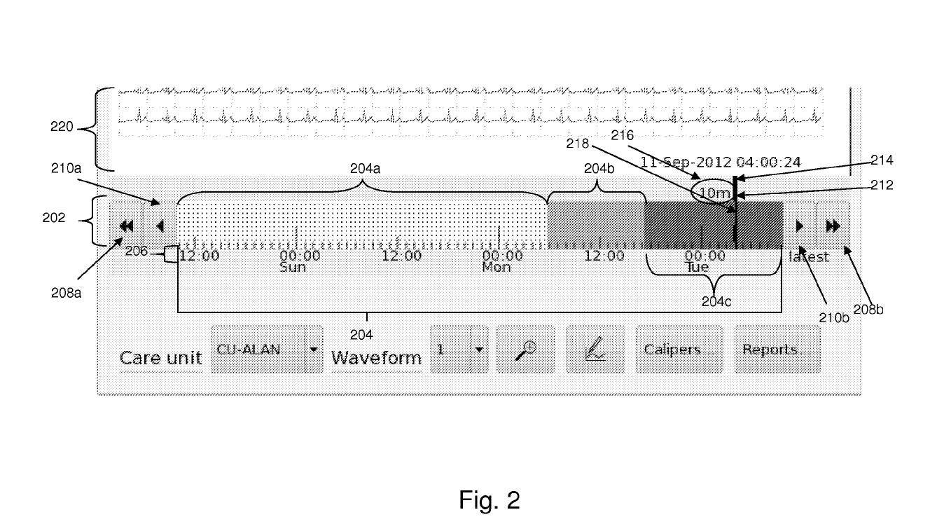

The operation of the central monitoring device 102 that displays patient medical parameter data and provides a user with the ability to navigate between different data display windows having different types or different versions of patient medical parameter data will be described hereinafter with respect to FIGS. 2-25. All reference to components responsible for executing and controlling the various features of the system will be described with respect to the elements shown in FIG. 1.

FIG. 2 is an exemplary screen shot of a portion of a user interface display image generated by the display processor 108 and displayed on a display device 110 in response to instructions received from the controller 104. The portion of the display image includes an image element representing a navigation bar 202. The navigation bar 202 selectively displays information pertaining to the type of data associated with a particular patient and enables a user to interact therewith using an I/O device 112. The controller 104 may selectively control the format and information shown within the navigation bar 202 based on the type of display image currently being displayed and at least one type of configuration parameter.

The navigation bar 202 includes a first visual band 204 that represents a time frame for patient medical parameter data able to be navigated. A time bar 206 is generated and displayed adjacent the first visual band 204. The time bar 206 includes a time scale over a period of hours, days, minutes that allows the clinician to instantly view the first visual band 204 of the navigation bar 202 and ascertain information associated with the patient medical parameter data at a given time in the time scale. The first visual band 204 may be dynamically configured into at least two display regions by the display processor 108 in response to the controller analyzing the patient medical parameter data acquired by the acquisition processor 106. The number of dynamically configured display regions in the first visual band 204 may be visually distinct from one another in order to represent different types of information. Visual distinction may be accomplished by having each of the at least one regions being displayed using different colors and/or different shading patterns. In one embodiment, the first visual band 204 may represent a time frame ranging from at least 72 hours to 120 hours. This is described for purpose of example only and any time range may be represented via the first visual band 204. In the embodiment shown herein, the first visual band 204 is dynamically configured into three display regions 204a-204c associated with the patient medical parameter data for the particular patient. A first display region 204a may indicate that, for the given time period within the first display region 204a, there is no patient medical parameter data associated with the patient at that time and will not ever be populated. For example, if the first visual band 204 represents a time frame of 72 hours but a size of a database selected by a clinician is less than 72 hours, the display processor 108 may configure the first display region 204a to visually indicate that a portion of the 72 hours represented by the first visual band 204 will not include or ever include any patient medical parameter data. A second display region 204b represents a section of the patient parameter database 12 associated with that patient that currently has no patient medical parameter data populated therein but will eventually be populated with patient medical parameter data at a later time. A third display region 204c represents a section of the patient parameter database 12 associated with the patient that includes patient medical parameter data populated therein. Thus, an area of the first visual band 204 that includes sections 204b and 204c represents a total size of a patient medical parameter database selected and acquired by the acquisition processor 106. Exemplary patient medical parameter database sizes may be any of 2 h, 28 h, 48 h, 72 h, 96 h and/or 120 h. In another embodiment, the system 100 may select different size patient medical parameter databases associated with different patients and the display processor automatically updates the navigation bar 202 to reflect the aspects of the selected patient medical parameter databases associated with different patients. The size of the various display regions 204a-204c relative to one another is dynamically and automatically updated by the display processor 108 based on information about the data presently in the patient parameter database. For example, the size of the second display region 204b relative to the first display region 204a and the third display region 204c may decrease once patient medical parameter data is populated in the patient parameter database and subsequently acquired by the acquisition processor 106.

The navigation bar 202 further includes first scroll elements 208a and 208b, referred to collectively by reference numeral 208, and second scroll elements 210a and 210b, referred to collectively by reference numeral 210. The first scroll elements 208 may be user selectable image elements that enable a coarse scrolling through the set of data in the patient parameter database. Selection of scroll element 208a enables coarse scrolling through data in the database occurring earlier in time than the currently displayed patient medical parameter data. Selection of scroll element 208b enables coarse scrolling through data in the database occurring later in time than the displayed patient medical parameter data. The second scroll elements 210 may be user selectable image elements that enable fine scrolling through the set of data in the patient parameter database. Selection of scroll element 210a enables fine scrolling through data in the database that occurred earlier in time. Selection of scroll element 210b enables fine scrolling through data in the database that occurred later in time. In response to selection of one of the scroll elements 208 or 210, the display regions 204a-204c in the first visual band are automatically updated by the display processor 108 to indicate to the user information about the patient medical parameter data in the patient parameter database at the given time as indicated by the date and time in the time bar 206.

The display processor 108 may generate an image element representing a second visual band 212. The second visual band 212 represents a user selectable window identifying a range of acquired patient medical parameter data to be displayed within the data display window 220. The second visual band 212 represents a predetermined amount of patient parameter data corresponding to a predetermined amount of time and which is currently being displayed in data display window 220. The second visual band 212 extends across an entire height of the first visual band 204 and therebeyond to connect to an edge of the data display window 220 at connection point 214. By being positioned entirely within the first visual band 204 and extending to the data display window 220, the second visual band 212 provides a direct visual link between the patient medical parameter data being displayed in data display window 220 and the predetermined time window shown in the first visual band 204. Thus, the navigation bar 202 is linked to the data display window 220 via the second visual band (e.g. user selectable window). It is important to know that connection point 214 is not static and may vary depending on the position of the second visual band 212 within the first visual band 204. The display processor 108 insures that the connection point 214 remains along the bottom edge of data display window 220 and is directly aligned with the position of the second visual band 212. The second visual band 212 may be selectively positionable via a user I/O device 112 at any position within the first visual band 204. By positioning the second visual band 210 at various points within the first visual band 204, a set of patient parameter data over the predetermined time frame indicated by the second visual band 212 is automatically displayed within data display window 220.

A window indicator 216 may be displayed adjacent the second visual band 212 in a space between the first visual band 204 and the bottom edge of the data display window 220. The window indicator 216 identifies an amount of time represented in the predetermined time window indicated by the second visual band 212. The length of the predetermined time window associated with the second visual band 212 may be selectively configured by a user to one of increase or decrease the amount of time and corresponding amount of patient medical parameter data being displayed in display window 220. In response to modifying the time of the second visual band 212, the window indicator 216 is caused to change to reflect the updated time range. Additionally, the display processor 108 automatically updates a size of the second visual band 212 to indicate that the time window has one of increased or decreased in size.

The navigation bar 202 may also include at least one event indicator 218 that corresponds to a clinically significant medical event determined to occur. The event indicator 218 may be displayed in any color or pattern that enables it to be sufficiently distinguished from the indicator of the display region in which it resides and also differs from the visual depiction of the second visual band 212. Should the clinician wish to view data associated with the event, the clinician may select the second visual band 212 and drag the band to a position within the first visual band 204 that is near (within a predetermined number of pixels on either side) the event indicator 218. The controller 104 automatically detects the position of the second visual band 212, calculates whether or not the second visual band is near the event indicator 218 by determining if a current pixel location associated with the second visual band 212 is within a predetermined distance on either side of a pixel location of the event indicator 218. If the determination is positive, the controller 104 automatically repositions the second visual band 212 within the first visual band 204 such that the event indicator 218 is located at substantially a center point of the predetermined time window defined by the second visual band 212. The controller 104 automatically snaps the second visual band 204 to the position within the first visual band encompassing the event indicator 218 ensuring that the clinician will be presented with the patient medical parameter data related to the determined event that was sought when the clinician initially moved the second visual band 212. Thus, navigation is more intuitive and precise. The display processor 108 automatically connects the time window represented by the second visual band 212 with a bottom edge of the data display window 220 creating the direct visual link indicating that data being displayed in the data display window 220 has occurred within the time frame indicated by the second visual band 212.

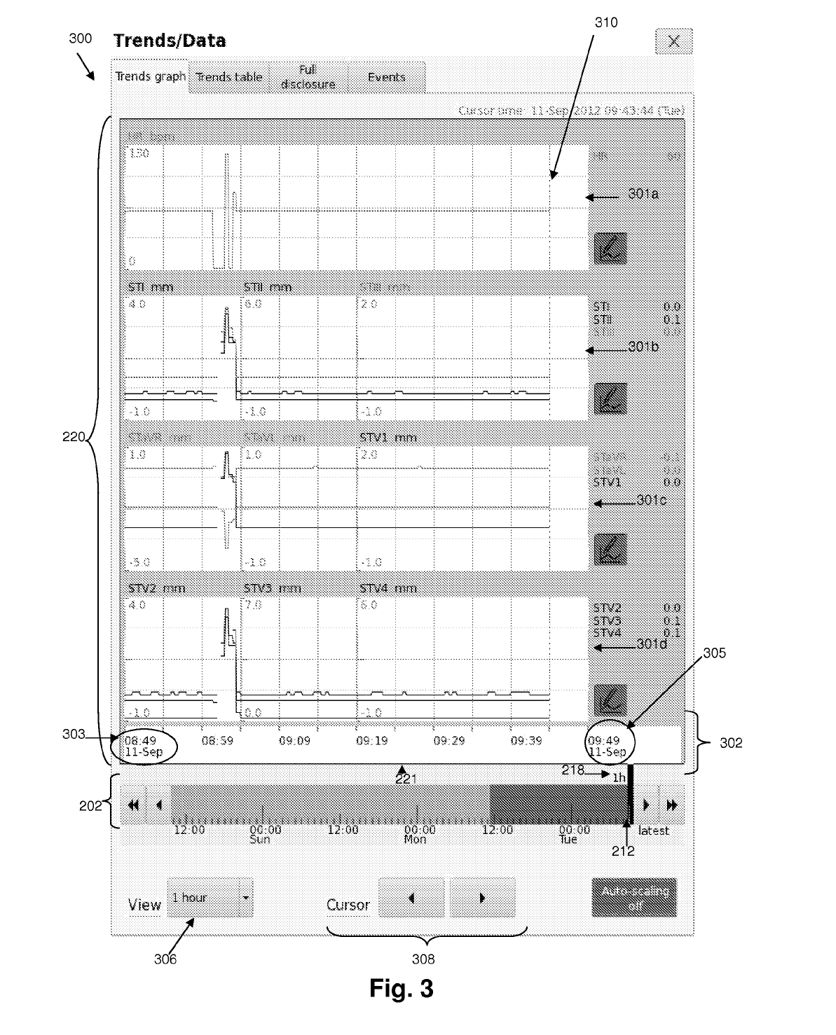

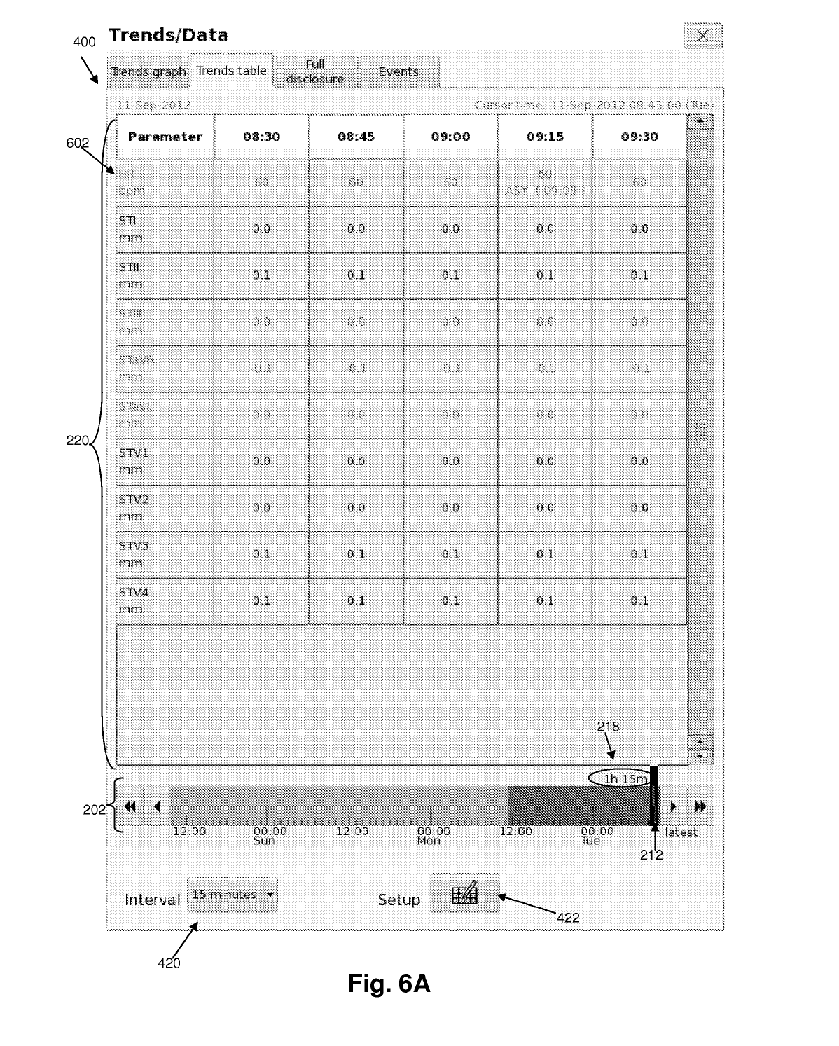

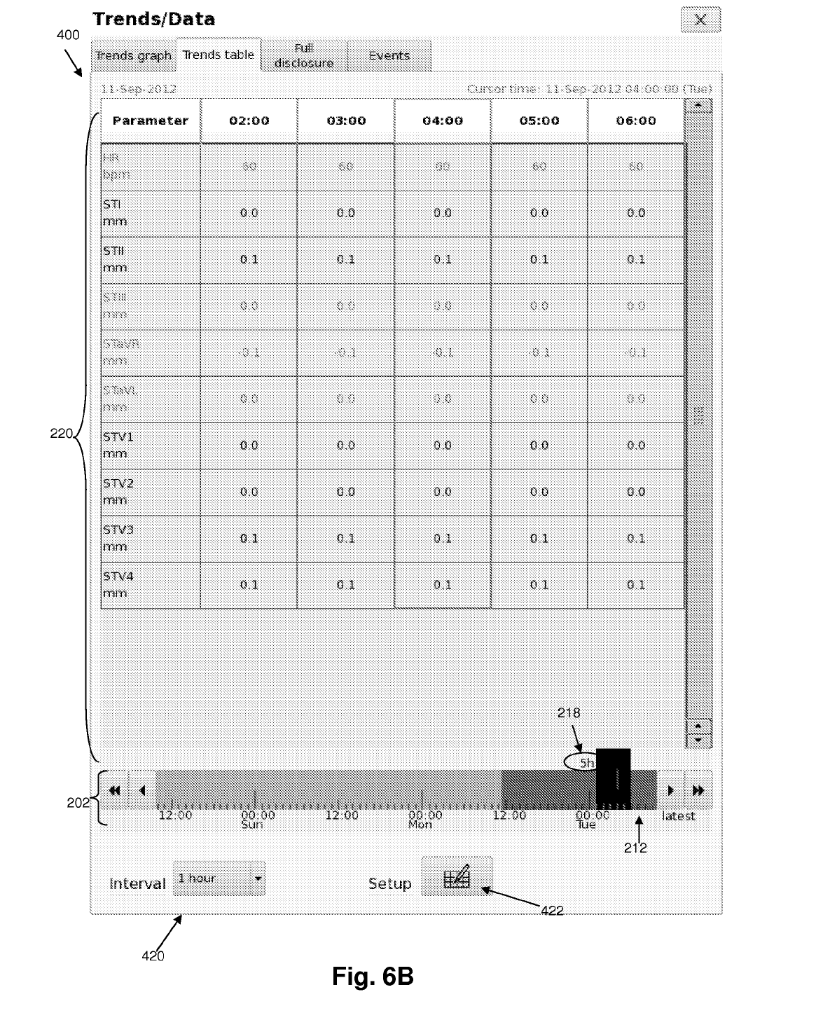

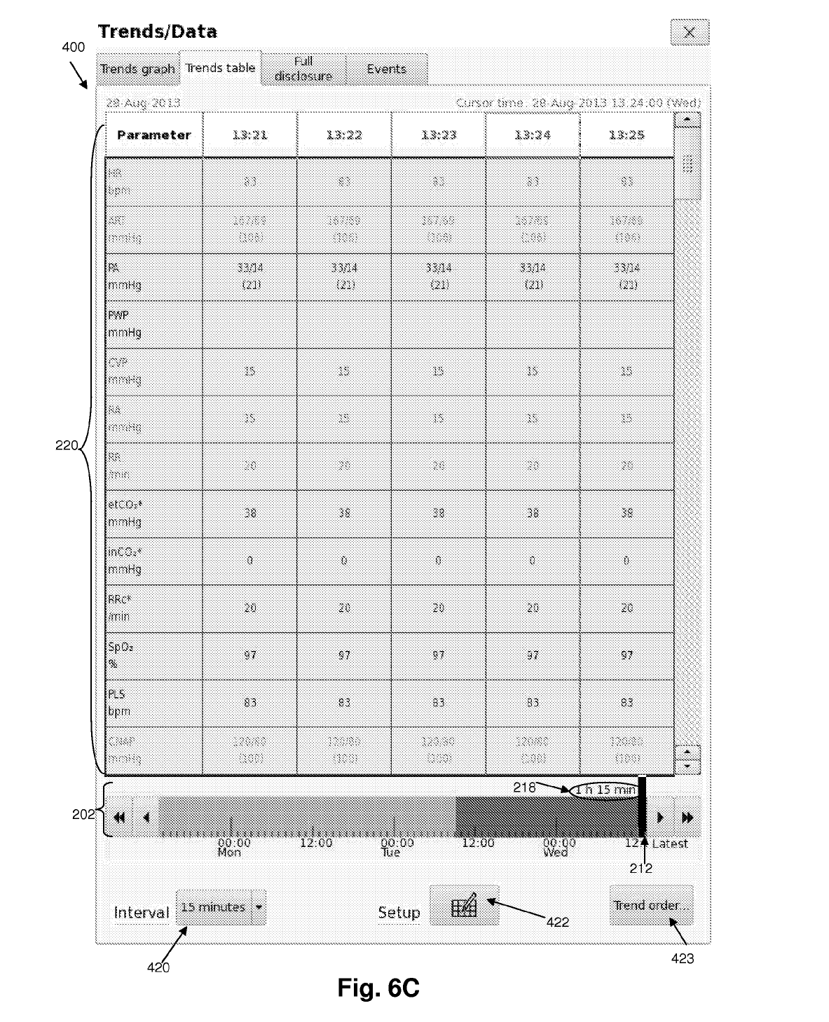

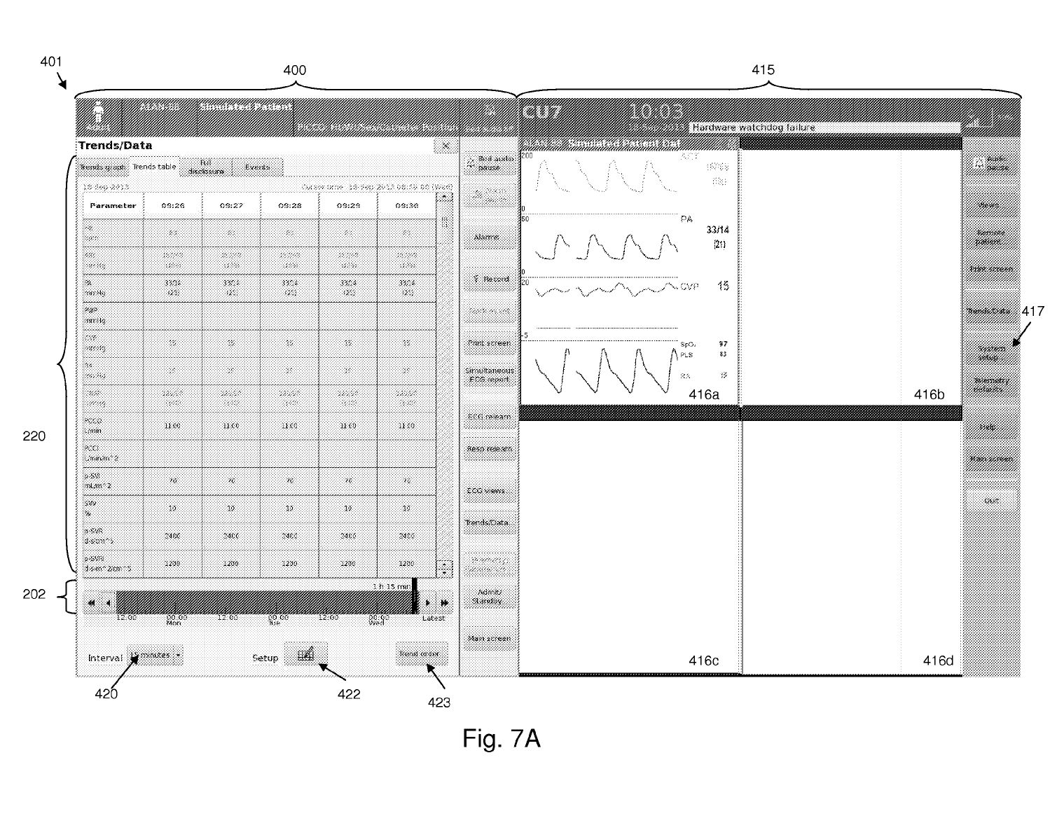

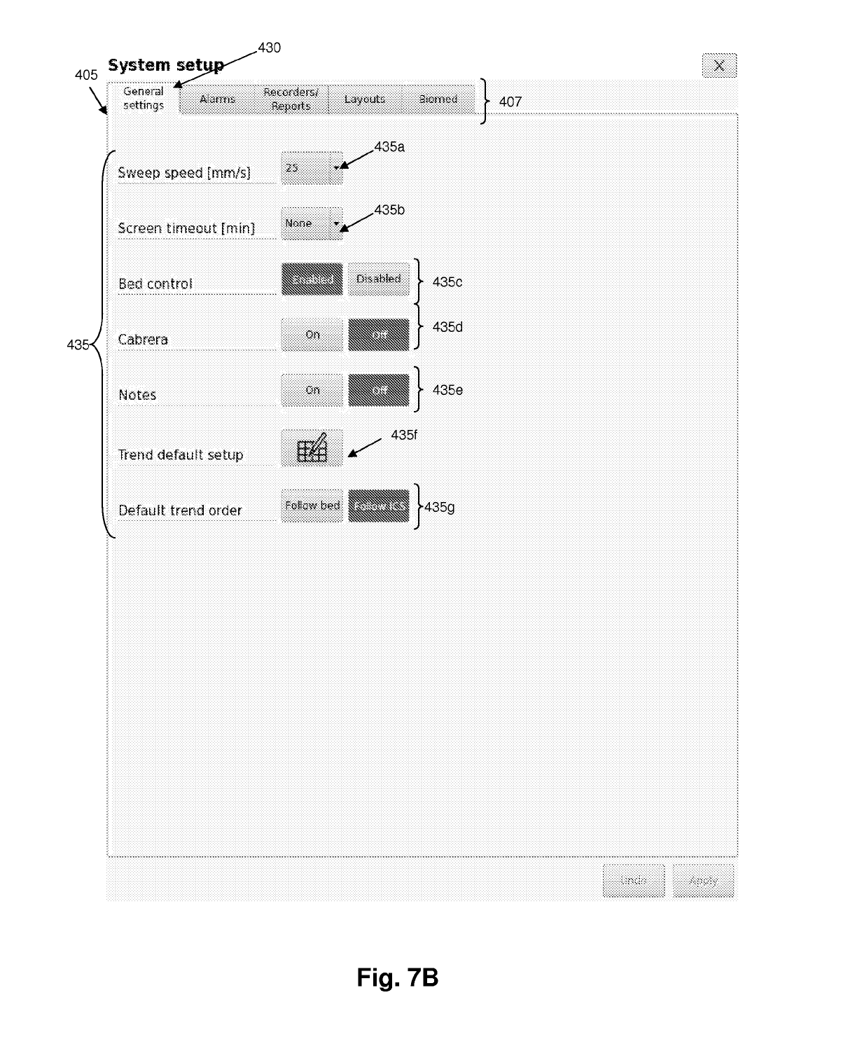

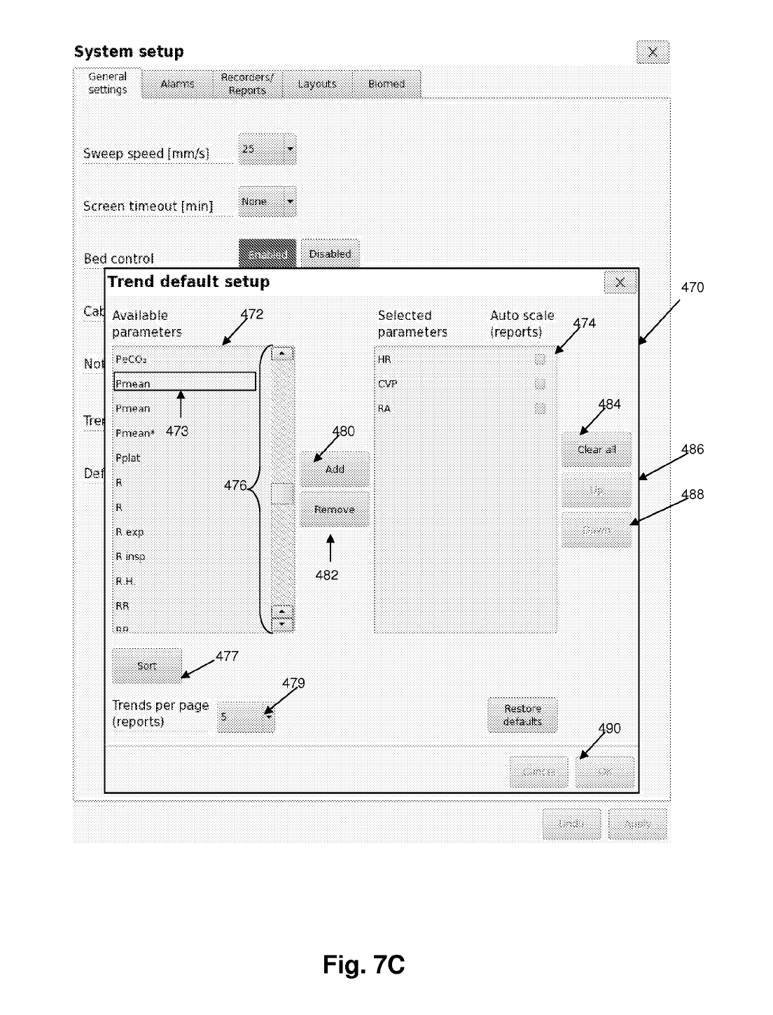

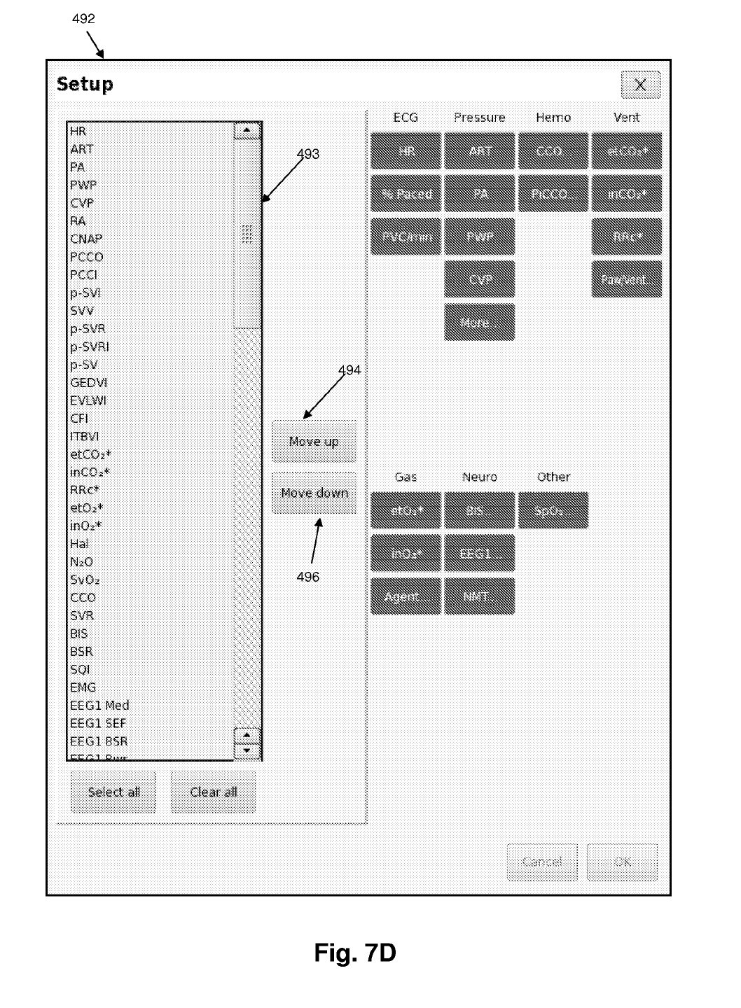

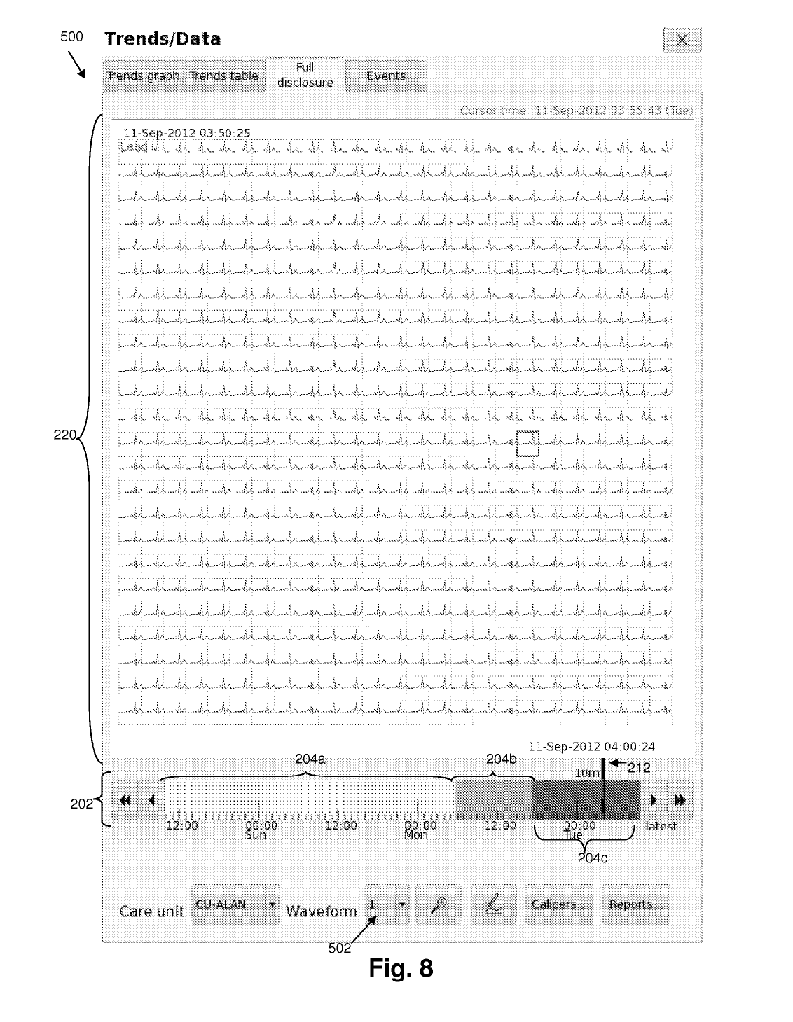

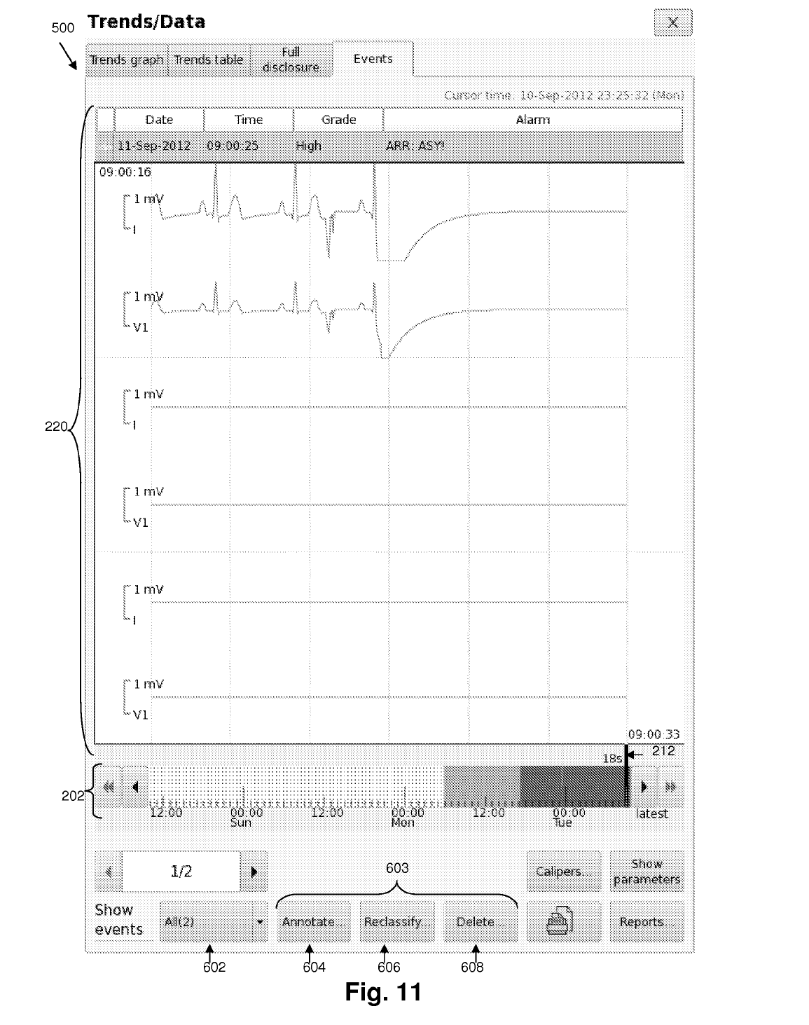

FIGS. 3-11 depict exemplary screen shots generated by the system according to invention principles. The system advantageously generates different display images representing different views of the same set of patient medical parameter data. A first type of display image generated by the display processor 108 is a graphical trend display image (300 in FIGS. 3-5) that displays at least one type of patient medical parameter over a duration. A second type of display image generated by the display processor 108 is a trend table display image (600 in FIGS. 6 and 7) that displays at least one type of patient medical parameter in tabular form over a duration of time. A third type of display image generated by the display processor 108 is a full disclosure display image (500 in FIGS. 8-10) that displays the at least one patient medical parameter in a raw and unprocessed format. For example, if the at least one patient medical parameter is ECG data, then the full disclosure display image will display the ECG waveform. A fourth type of display image is an event display image (600 in FIG. 11) that displays the at least one patient parameter data surrounding a clinically significant event that occurred for the particular patient. The display processor 108, in each user interface display image generated thereby, provides user selectable image elements enabling toggling between the respective different display images. In on embodiment, a series of image tabs may be generated and, in response to user selection thereof, the display processor 108 changes the type of image being displayed at the present time.

FIG. 3 is an exemplary graphical trend display image 300. The display image 300 includes the data display window 220 in which the at least one patient medical parameter data is being displayed. The display image 300 further includes the navigation bar 202 including substantially the same elements operating in a similar manner as the navigation bar described above with respect to FIG. 2 and are not repeated here. As shown herein, four different patient medical parameter data 301a-301d are being displayed in the data display window 220. This indicates that the patient medical parameter data acquired by the acquisition processor included these four different parameters 301a-301d. While four patient parameters are shown herein, the display processor 108 can automatically configure the display image to include all or any combination of patient parameter data acquired by the acquisition processor 106 for a given period of time.

As shown herein the second visual band 212 is positioned at substantially a latest point in time with respect to the patient medical parameter data that has been acquired and is being displayed in display window 220. In the embodiment shown herein, the second visual band 212 represents a time window of one (1) hour as depicted by the window indicator 218. Moreover, the second visual band 212 extends above the navigation bar 202 and connects to a bottom edge 221 of data display window 220 thereby creating a visual link between the data being displayed and the time and position of the patient medical parameter data in the patient parameter database. To provide additional information to the clinician or user, the data display window includes a timeline 302 that includes time markers in predetermined time increments. The time markers represent the time within the time window defined by the second visual band 212. The timeline 302 includes a start indicator 303 identifying the date and time when the patient parameter data was acquired and represents the start time of the time window defined by the second visual band 212. The time band 302 also may include an end indicator 305 identifying a date and time on which the patient parameter was acquired and the end time of the time window defined by the second visual band 212. The second visual band 212 may be selectively moved within the first visual band (204 in FIG. 2) of the navigation bar enabling the clinician to select and display patient medical parameter data at any given date and time that may be present in the database. In response to movement of the second visual band, the patient medical parameter data being displayed in window 220 automatically changes to reflect the patient medical parameter data at the newly selected time within the window defined by the second visual band 212.

The display image 300 further includes a window selection image element 306 that enables the user to selectively define the window of time associated with the second visual band 212. The window selector 306 provides a drop down list of window durations that is populated by a list of candidate window durations that are selectable by the user. In another embodiment, the window selector 306 may be a user-fillable field that allows the user to selectively define the duration of the window associated with the second visual band 212. Additionally, in response to selecting a new window duration, the size (e.g. width) of the second visual band may increase or decrease depending on how the newly selected duration compares to the previously selected duration. Moreover, the increments between the time markers in time band 302 may automatically change in response to a change in the duration thereby ensuring that all relevant patient medical parameter data in the selected window of time may be displayed to the clinician.

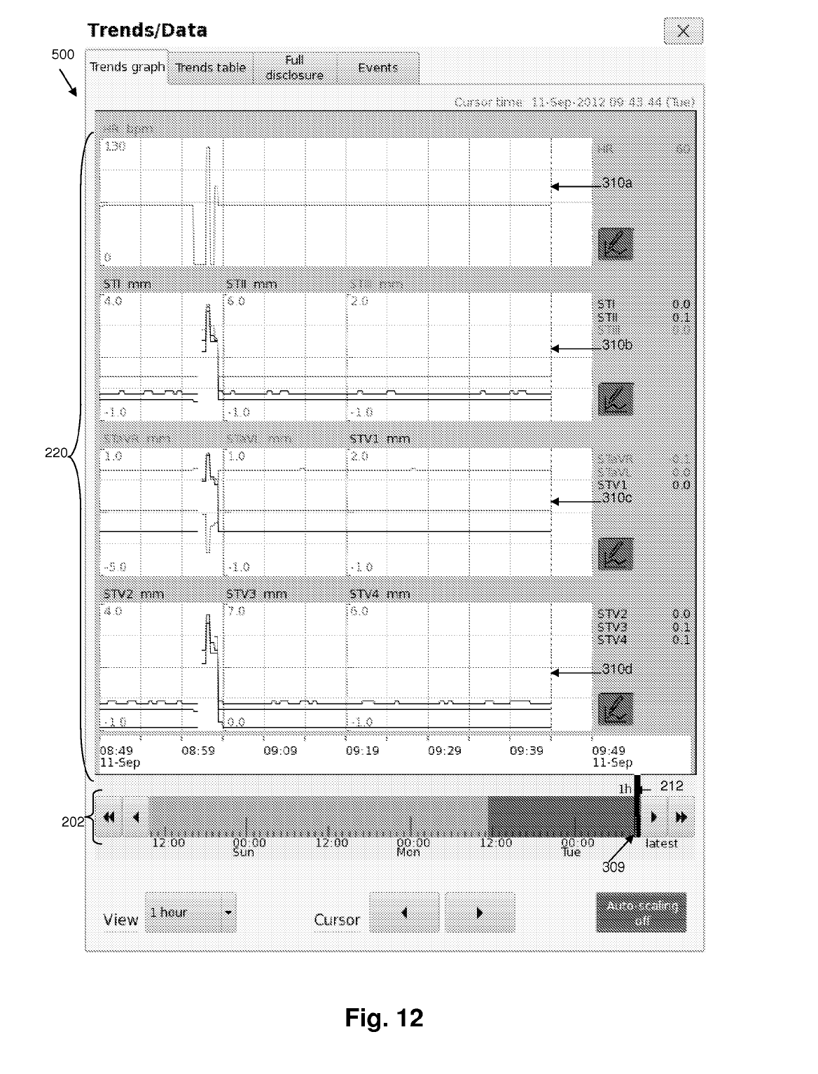

The display image 300 further includes cursor selection elements 308 that selectively enable a user to define a position of a cursor 310 within the data display window. The system enables the cursor 310 to be moved to any point presented within the first visual band. As shown herein, the cursor 310 is positioned at the latest point in time for which data has been collected as there is no patient medical parameter data occurring after (e.g. to the right) of cursor 310. The additional features of the cursor 310 will be discussed hereinafter with respect to FIGS. 12-22).

However, as will be seen in the following discussion each display image includes a data display window and the navigation bar 202. By having a common navigation bar 202 that operates in a similar manner no matter the type of display image being displayed simplifies system operation and provides the user with a uniform and intuitive mechanism for navigating between display images as well as between different types of patient medical parameter data presented in differing formats that are present at different locations within a patient medical parameter database.

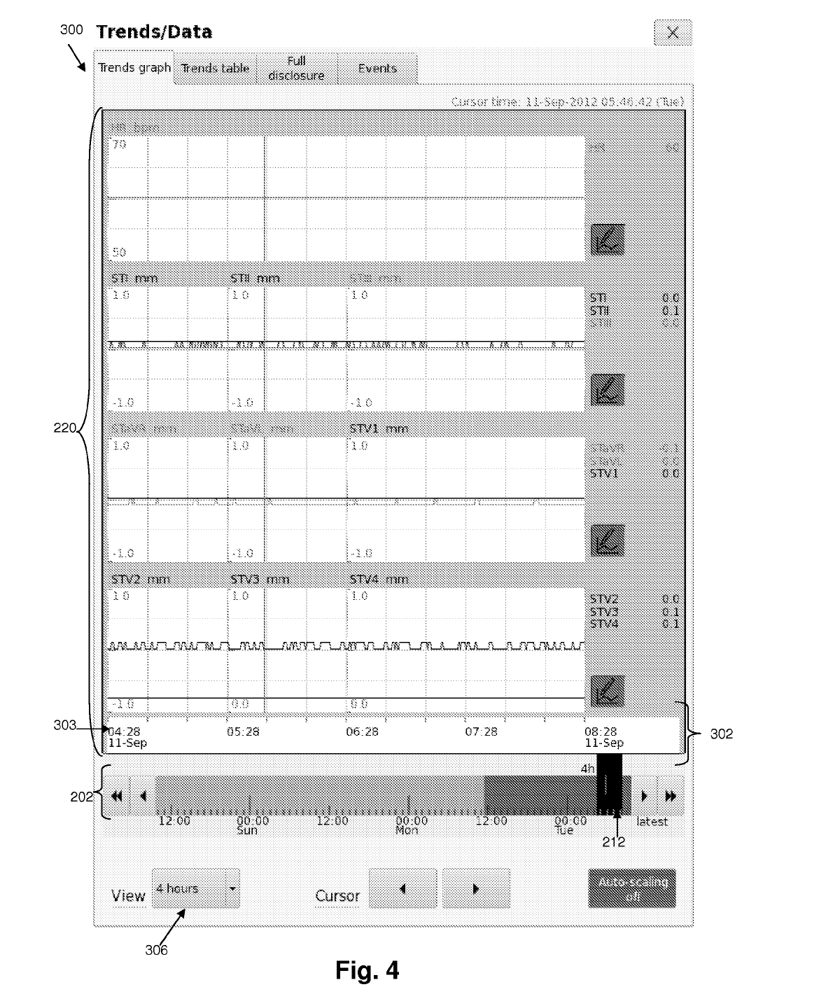

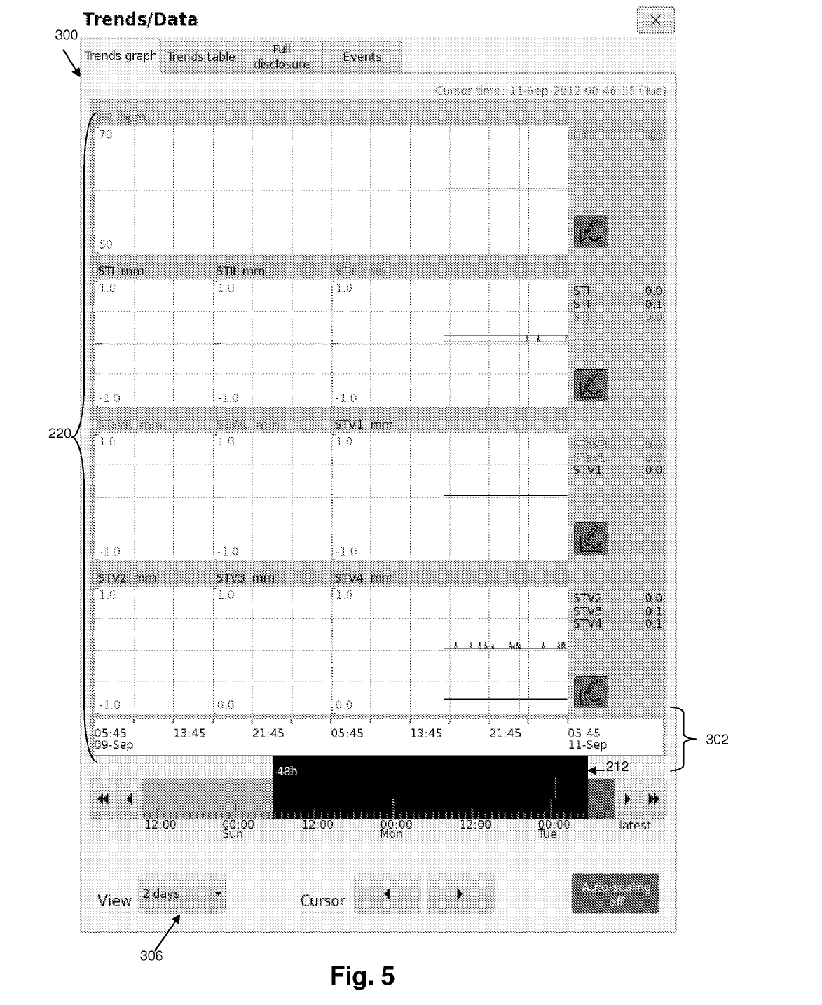

FIGS. 4 and 5 are exemplary screen shots of the graphical trend display image shown in FIG. 3. The individual elements of FIG. 3 are the same with the difference being the duration indicated by the window selector 306 for the window of time associated with the second visual band 212. As shown in FIG. 4, the window selector 306 has been set to be equal to four hours. In response to setting the window equal to four hours, the controller 104 provides the display processor 108 with patient medical parameter data for the four hour period within the window defined by the second visual band 212. The display processor 108 selectively displays the patient medical parameter data over the selected four hour period in data display window 220. Additionally, in response to a change in the window of time, the values in the time band 302 are automatically adjusted by modifying the number and position of the individual time markers as well as the increments of time therebetween in order to accommodate the newly selected set of patient medical parameter data within the newly selected window of time defined by the second visual band 212. As the amount of data within the window has increased, the level of detail associated with the patient medical parameter data being displayed is reduced as compared to that shown in FIG. 3. FIG. 5 is another screen shot of display image 300 where the window selector 306 has been set equal to 2 days causing the display processor 108 to display two days' worth of patient parameter data. As can be seen herein, in response to setting the window of time equal to two days, the display processor 108 causes the second visual band to increase in size thereby quickly and easily providing information to the clinician about the amount of patient medical parameter data being displayed in display window 220.

FIGS. 6A-6C represent screen shots of tabular display images 400. The tabular display images 400 include a tabular depiction of patient medical parameter data displayed in display window 220. The tabular depiction of data may include a series of columns that correspond to predetermined time intervals within the window of time defined by the second visual band 212 such that a number of columns displayed therein is equal to the number of time intervals occurring within the window. The tabular depiction of data further includes a series of rows wherein each row represents a unique patient medical parameter. The tabular display further includes a plurality of individual fields associated with respective time intervals and a respective patient medical parameter data. Present in each data field is a numerical value associated with and describing the particular patient medical parameter during the respective time interval. For example, in a first row 602, the patient medical parameter data represents patient heart rate in beats per minute. The values in the columns represent an average beat per minute heart rate for the patient at each interval within the time window associated with the second visual band 212. Tabular trend display image 400 includes an interval selection image element 420 that allows the user to selectively define a duration of time for the intervals to be displayed in data display window 220. As shown herein, the intervals are set equal to 15 minutes and a window of time associated with the second visual band 212 is set equal to an hour and fifteen minutes. The display image 400 includes a window indicator 218 indicating a duration of the time window for which patient medical parameter data is being displayed. The window indicator 218 and interval indicator 420 are displayed proximate to the second visual band 212 providing the clinician with a quick summary defining how the patient medical parameter data over a period of time defined by the window and at the particular position in the patient parameter database is being displayed in the data display window 220. The user may selectively move the second visual band 212 to any point along the navigation bar 202 and the display processor 108 will automatically update the patient medical parameter data being displayed in the data display window 220. FIG. 6B is another exemplary screen shot of the tabular trend data display image 400. FIG. 6B differs from FIG. 6A in that the interval duration as determined by the interval selector 420 in FIG. 6B is set equal to 1 hour and the window of time associated with the second visual band 212 is set equal to 5 hours as shown by window indicator 218. Thus, display image 400 in FIG. 6B similarly includes 5 columns representing the hourly intervals set by the system and displays a trend of the patient medical parameter data over each interval.

FIG. 6C is a further exemplary screen shot of a tabular trend data display image 400. The display image 400 in FIG. 6C is formatted according to a formatting parameter that is at least one of (a) selected by a user; and (b) automatically detected based on a type of connection to the patient. In one embodiment, the display image 400 in FIG. 6C may be formatted according to a first formatting parameter representing a patient monitoring device format. In this embodiment, the patient monitoring device format automatically configures the type of patient parameters to be displayed in the display window 220 as well as the order in which the patient parameters will be displayed. Thus, the type and position of the patient parameters monitored by a patient monitoring device will be mirrored in the display image 220. This mirroring of the patient monitoring device display screen may include all patient parameters able to be monitored by the patient monitoring device even if there is no data currently associated with the parameter. Alternatively, the formatting parameter may represent a central formatting parameter that represents a tabular format being used by a central monitoring device. In this example, the display image 400 is configured to arrange patient parameter data in a particular order set by a clinician or user responsible for monitoring a plurality of patients at a central patient monitoring station. This enables the clinician responsible for monitoring the patient to view all patient parameters for all patients in a particular desired order most convenient to them. While the user/clinician may select the formatting parameter for the particular tabular trend display image 400, the system, may also automatically default to a default formatting parameter. For example, if the system determines that no patient monitoring device is present, the system may automatically select one of a (a) central monitoring format currently in use by the central monitoring station; or (b) a database format representing a patient parameter display format associated with the patient parameter database from which the patient data is being acquired.

FIG. 6C also includes a trend order selector image element 423 that enables the user to selectively configure the display order of the patient medical parameters in the display window 220. The display order for the patient medical parameters in display window 220 is configured using formatting data derived from a source of formatting data. The formatting data may be derived from the patient monitoring device from which the original patient medical parameter data was/is acquired. Alternatively, the formatting data may include a default display order or be defined by a user as will be discussed hereinafter with respect to FIGS. 7A-7C. By selecting the trend order selector image element 423 from within the tabular trend display image 400, the user/clinician is advantageously able to automatically re-order the display of the patient medical parameter data within display window 220 using the other type of formatting data. For example, if the tabular trend display image 400 has been configured to use formatting data from the patient monitoring device, selection of the trend order selector image element 423 automatically re-orders the patient medical parameter data using one of the (a) default parameter display order associated with the central monitoring device and (b) a user configured parameter display order as described below in FIG. 7C. In another embodiment, selection of the trend order selector image element 423 generates a pop-up window including further selectable image elements corresponding to the various sources from which formatting data may be derived. In this embodiment, selection of image element 423 may generate a window having a “follow bed” icon indicating that the formatting may be derived from a patient monitoring device and a “follow ICS” icon indicating that the formatting data may be derived from the central monitoring device itself. Further, in this pop-up window, the image element from which the current formatting data is derived may appear visually distinct (e.g. different color, bold, highlighted, etc) from any other image element to quickly notify the user of the source of the formatting data. Should the user wish to change the source of formatting data and re-order the display order, selection of another image element in the pop-up window will allow the system to automatically re-order the display order of the patient medical parameter data in the display window 220 of the tabular trend display image 400.

The system further advantageously enables a user/clinician to configure the formatting of respective display images 400 in any of FIGS. 6A-6C. The formatting of the respective display images 400 in FIGS. 6A-6C may be determined using a globally set formatting parameter that identifies the source of formatting to be used to generate display images 400. FIG. 7A provides an expanded display image 401 that includes the tabular trend display images 400 along with a composite monitoring window 415 that includes at least one window 416a-416d having patient parameter data associated with a respective one of the plurality of patients being monitored by the central monitoring device displayed therein. The composite monitoring window 415 is positioned adjacent the tabular trend display image 400 which represents trend data for one of the patients being monitored. In the expanded display image 400a, a system setup image element 417 is provided. Selection of this image element 417 automatically generates a global configuration display image 405 shown in FIG. 7B. The global configuration display image 405 enables the user to selectively configure a plurality of formatting parameters that will be applied across the various display images generated by the central monitoring device. The global configuration display image 405 enables generation of formatting data that is associated with the central monitoring device and which may be selected in various screens by selecting a “Follow ICS” image element. The formatting data generated may be used to configure the display order of the patient medical parameter data in the tabular display image 400 in any of FIGS. 6A-6C. While the configuration of tabular trend display image 400 is described herein, the resulting configuration generated by selection of the setup image element 422 may automatically be applied to the graphical trend display images shown in FIGS. 3-5.

Selection of the system setup image element 417 in FIG. 7A results in the generation of global configuration display image 405 shown in FIG. 7B. Global configuration display image 405 may include a plurality of tabs 407 enabling a user to selectively configure various configuration parameters associated with the various types of display images. FIG. 7B depicts a first general setting tab 430 that includes at least one type of user definable global formatting parameter, collectively referred to with reference numeral 435, to be used in generating any type of display image by the system. Global formatting parameters 435 may include at least one of (a) a sweep speed parameter value 435a; (b) a screen time out parameter value 435b; (c) a bed control parameter 435c; (d) a Cabrera control parameter 435d; (e) a notes control parameter 435e; (f) a trend default setup selector 435f; and (g) a default trend order selector 435g.

The sweep speed parameter value 435a represents the sweep speed of the waveforms and determines how fast the refresh bar sweeps across the screen to update the waveforms. The screen timeout parameter value 435b selectively configures the amount of time the screen will display without user interaction before automatically returning to a prior display image (e.g. a main display image that shows the patient parameter data according to the previous settings). The bed control parameter 435c selectively configures whether certain functions of a patient monitoring device may be controlled by the central monitoring station. An example of a function of a patient monitoring device that may be controllable by the central monitoring station includes monitor audio control wherein a clinician at a central station may be able to selectively enable/disable a particular type of alarm being emitted by the patient monitoring device from central station. The control of the audio from the patient monitoring device is merely one example of a type of function that may be controlled using the central monitoring station and any other type of function may be selectively controlled by the central monitoring station. The Cabrera control parameter 435d selectively enables a user to configure the display of ECG data to be displayed in either a Cabrera presentation format or another presentation format. The Cabrera presentation includes configuring the displaying of the limb leads in the following sequence aVL, I, -aVR, II, aVF, III. The notes control parameter 435e selectively displays a further window within any of the display images enabling a clinician to enter notes about the particular patient that may be relevant in supporting the care of the particular patient. The notes control parameter 435e may enable generation of at least one of (a) a free form text entry window able to receive text input via a keyboard (actual or image-based) or via an input device such as a stylus; and (b) a selection menu including a plurality of candidate types of notations to be included.

The general settings tab 430 also includes the trend default setup selector 435f. The trend default setup selector 435f results in generation of a trend default setup window 470 shown in FIG. 7C. The values and configuration determined using the trend default setup selector 435f may automatically become the central station formatting parameter used by the system for formatting the display image. Trend default setup window 470 includes a set of available types of patient parameters that may be monitored by the system and which may be selected by a clinician for display in any type of tabular or graphical trend display image. The available types of patient parameters may be included in an available parameter window 472. The available parameter window 472 includes a candidate set of available types of patient parameters that may be selectively included in a display image. A user may selectively scroll through the list of candidate types of patient parameters using a scroll image element 476. The user may also modify the manner in which the candidate types of patient parameters are displayed by selecting a sorting image element 477 that selectively sorts the available patient parameters using a sorting parameter (e.g. alphabetical; most frequently selected; medical care unit specific parameters, etc.). Any sorting parameter may be used by the system.

The trend default setup window 470 also includes a selected parameter window 474 the displays the types of patient parameters that have been selected from the candidate list of available types of patient parameters shown in window 472. In operation, a user/clinician may select at least one of the available patient parameters from window 472 using any manner of selection or input device, including but not limited to a mouse, a keyboard, a touch screen selection, etc. The selected patient parameter 473 may be highlighted to provide a clear indication to the user/clinician of the selected parameter. Thereafter, selection of an add image element 480 results in the automatic population of the selected parameter window 474 with the highlighted patient parameter. Similarly, if a user wishes to de-select or remove a parameter from the selected parameter window 474, the user may highlight the parameter in window 474 and select a remove parameter image element 482 and the patient parameter will be removed from the selected parameter display window 474. The removed parameter will be moved back into the available patient parameter window 472. Adjacent the selected parameter window 474 are order control image elements 486 (up) and 488 (down) which selectively enable the user to define the ordering of the selected patient parameters. A user may select a respective one of the parameters in window 474 and determine its position in the resulting display image with respect to the other selected patient parameters by selecting either the up image element 486 or the down image element 488. Additionally, a “clear all” image element 484 may be selected should the user wish to remove all selected parameters from window 474 and begin the configuration again. The trend default setup window 470 also enables the user to selectively define the number of trends that will be printed on a particular report page using selection image element 479. Once the user is satisfied with the configuration, an implement configuration image element 490 may be selected defining the central station formatting parameter that may be used by the system when generating tabular trend and graphical trend display image elements.

The default trend order selector 435g enables a user to select the source of the formatting data used in generating a trend display image such as those shown in FIGS. 3-5 and 6A-6C. The trend default selector 435g enables the user to automatically configure the order to trend parameters using formatting data derived from the patient monitoring device or default trend setup configured using the trend default setup window 470 in FIG. 7C. Thus, when a new patient is added to the central monitoring device, the system automatically uses the formatting data in configuring the trend display as determined by the selection made via the default trend order selector 435g. For example, If “Follow Bed” is selected the default trend order will match the display order of patient parameters on the patient monitor device. If “Follow ICS” is selected, the display order of the patient parameters is determined by one of (a) a default order of the central monitoring device; and (b) the display order defined using the trend default setup window 470.

Referring back to FIGS. 6A-6C, a current table setup image element 422 is provided. The current table setup image element 422 advantageously enables the user/clinician to re-configure the display order of the patient medical parameter data being displayed in display window 220. Selection of the current table setup image 422 results in the generation of current table configuration display image 492 in FIG. 7D. FIG. 7D includes a window 493 including a candidate set of patient medical parameter data that are available, the order of which may be selectively determined and configured using at least one of the up image element 494 or the down image element 496. The order selected using the display image 492 in FIG. 7D generates temporary formatting data that is used to selectively re-order the display order of the patient medical parameter data for that particular patient without affecting the display order for trend data associated with any other patients.

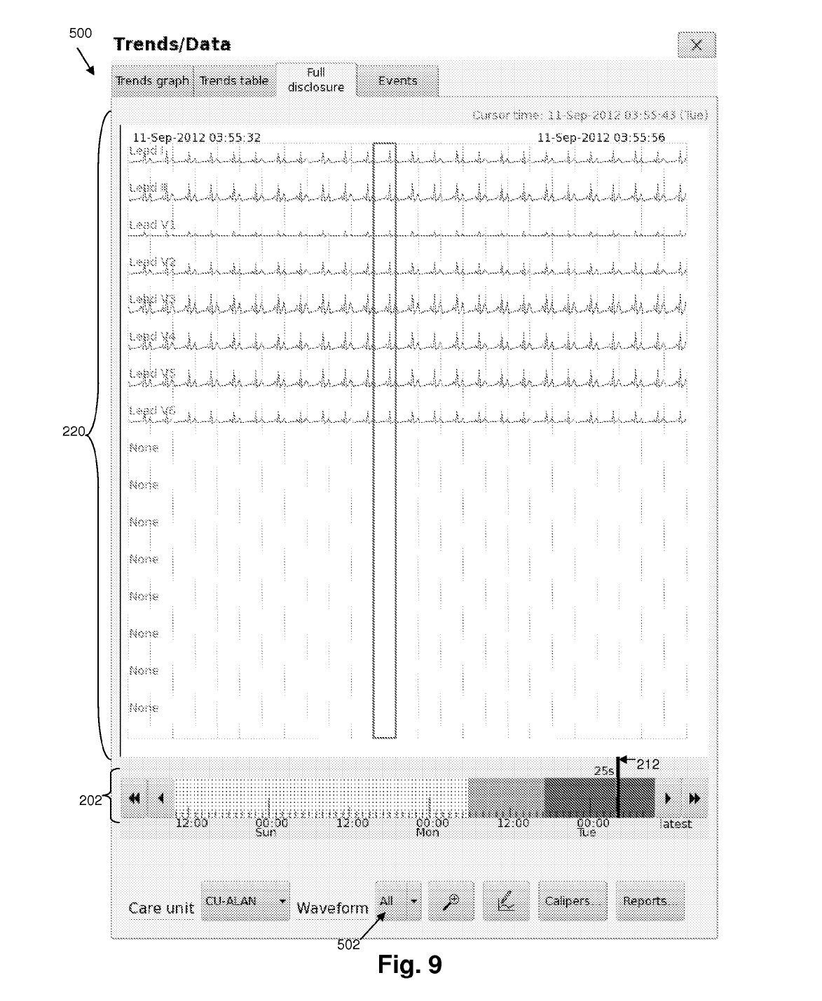

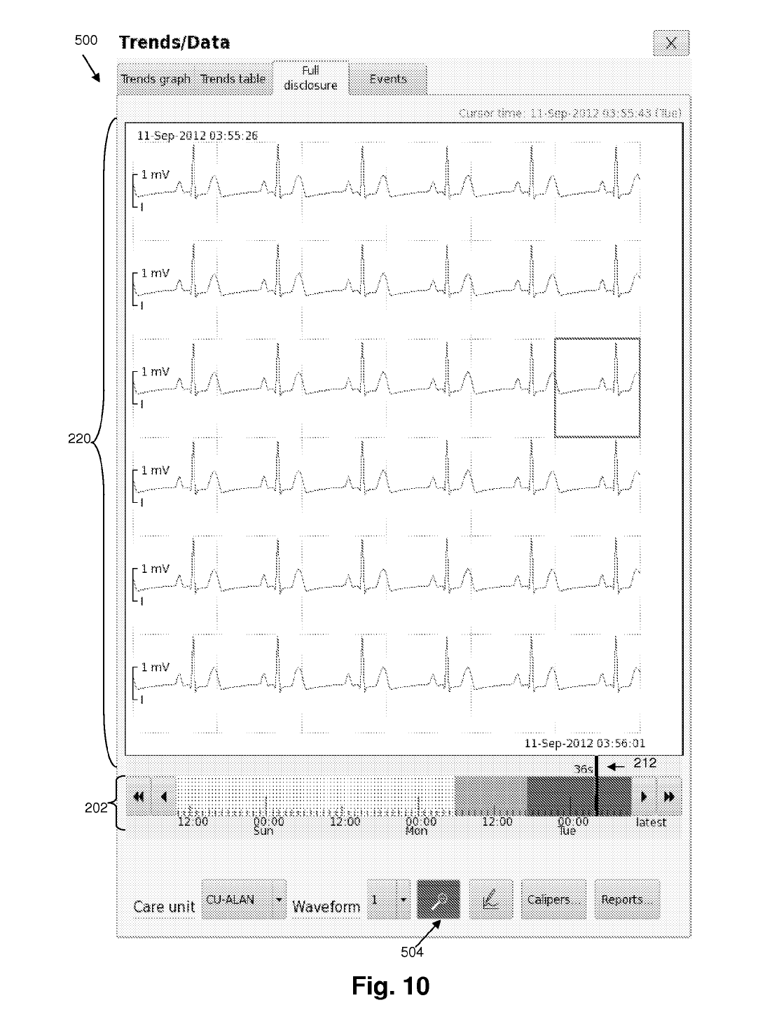

FIGS. 8-10 are screen shots of the third type of display image 500 that represents a full disclosure of the raw data associated with the patient medical parameter data acquired by the acquisition processor 106. Similarly to the display images in FIGS. 3-6, the full disclosure display image 500 includes the display window 220 for displaying patient medical parameter data therein and the navigation bar 202 enabling quick and efficient navigation and selection of data to be displayed in data display window 220. In the exemplary screen shot shown in FIG. 8, the patient medical parameter data displayed in data display window 220 is ECG data. Display image 500 includes a parameter selection image element 502 that enables the user to select at least one type of patient medical parameter data to be displayed. Thus, the parameter selector image element 502 provides a user selectable image element that may provide a candidate list of types of patient medical parameter data for selection and display in data display window 220. As shown herein, the selected type of patient medical parameter data is a waveform associated with a first ECG lead. This is shown for purpose of example only and the candidate list of types of patient medical parameter data may enable selection of any type of patient medical parameter associated with a patient that has been stored in the patient parameter database. The navigation bar 202 shown herein is similar to the navigation bar discussed above with respect to FIG. 2 and includes a timeline of the database. The timeline in FIG. 8 includes the first display region 204a that indicates no data is stored or will be stored therein. The second display region 204b is displayed in a visually distinct manner from the first region 204a thereby indicating that, while there is no data currently stored therein, these records associated with this time frame will eventually be populated by patient medical parameter data. The third region 204c is displayed in a visually distinct manner from both the first region 204a and second region 204b and indicates that, in this region of the database, patient medical parameter data is stored and available for display in data display window 220. The second visual band 212 is set in response to user command to be equal to a time window of ten minutes and is selectively positioned within the third region 204c. The second visual band 212 connects with the data display window 220 forming a direct visual link between the particular time window in the database and the data being displayed in data display window 220. This ability to navigate quickly by moving the second visual band 212 to any point in the navigation bar 202 enables the user to quickly select and view a large set of patient medical parameter data associated with the patient over a particular window of time. An alternate embodiment of the full disclosure display image 500 is shown in FIG. 9 wherein the parameter selector image element 502 has be set to display “ALL” patient medical parameter data over the given time window. Continuing with the above example wherein the patient medical parameter data is ECG data, by selecting “ALL” using the parameter selector 502, the controller 104 provides data acquired by the acquisition processor 106 and which represents all ECG leads during the time window identified by the second visual band to the display processor 108. The display processor 108 generates the display image 500 to include all patient parameter medical data and displays the data in data display window 220. FIG. 10 provides another embodiment of the display image 500 in FIGS. 8 and 9. As shown in FIG. 10, a user may select an image element 504 that enables the user to one of zoom in or zoom out on a particular portion of the patient medical parameter data being displayed in the data display window. By selectively zooming in, additional detail associated with individual patient medical parameter data samples are displayed in the data display window 220. Additionally, by zooming in, a size of the second visual band 212 is automatically adjusted to correspond to the zoomed in time frame thereby providing a visual indication as to the data being display relative to its position in the patient parameter database.

FIG. 11 is a screen shot of a fourth type of display image 600 for displaying patient medical parameter data associated with a clinically significant event. The event display image 600 includes an event selector image element 602 that allows a user to selectively determine which, if any, clinically significant events are to be displayed in data display window 220. In one embodiment, by selecting a clinically significant event using event selector 602, the controller automatically repositions the second visual band 212 along the navigation bar 202 at a point over an event indicator such that the event indicator is positioned at substantially a center point within the window defined by the second visual band 212. By scrolling through different clinically significant events, the system advantageously and automatically navigates to the position in the patient parameter database that includes patient medical parameter data associated with the clinically significant event and causes the data associated with the clinically significant event to be displayed in data display window 220. The event display image 600 may also include at least one type of action button 603 enabling the user to interact with the event specific data. An annotation image element 604 is provided and, upon selection thereof, provides a series of tools that allows a clinician to annotate any portion of the patient medical parameter data associated with the event. A reclassification image element 606 is provided and, upon selection thereof, enables the clinician to redefine patient parameter data as data representative of something other than a clinically significant event. For example, if, upon review of event specific data that the system indicates is associated with asystole, the clinician determines that asystole did not occur, selection of the reclassification image element advantageously enables that data to be identified in a different manner. In one embodiment, reclassification of data may result in an event indicator associated with a reclassified event being displayed in a different visual manner than an event indicator that is associated with an actual clinically significant event. This enables the reclassified event to be located easily for further review at a later time. A delete image element 608 may also be provided and enables a user to delete any portion of data selected by the user and within the data display window 220.

In addition to the navigation bar 202, the display processor 108 further advantageously adapts a visual display of a cursor image element generally referred to by reference numeral 310. The visual display of the cursor 310 may be automatically modified based on a position of the cursor within the data display window 220 of the respective display image. By modifying the visual display of the cursor 310, the system advantageously provides additional information about the data being displayed in data display window 220. The cursor modification performed by the system will be discussed hereinafter with respect to FIGS. 12-23. The system advantageously modifies the cursor by changing the visual display of a cursor. The visual display may be one of a first type of cursor display (e.g. solid line) that indicates the selected data will not change when the patient medical parameter data in the data display window 220 is updated or a second type of cursor display (e.g. dashed line) that indicates that the data at the selected position within the patient parameter data will be modified when the database is updated. In addition to the differing visual display of the cursor 310, the system provides two types of cursors. A first type of cursor is a fixed cursor that will remain positioned over a respective data sample selected by a user. Thus, if the cursor 310 is a fixed cursor, the display processor 108 will automatically maintain the cursor 310 in its position when generating new display images including subsequent patient medical parameter data. A second type of cursor is a floating cursor that may be positioned at one of an earliest point in time of the time window associated with the second visual band 212 or a latest point in time of the time window associated with the second visual band 212. If the cursor 310 is a floating cursor, the system automatically modifies the visual display thereof to be the second type of cursor thereby enabling the user to quickly understand that data at that point in the database will change in response to subsequent updates to the display image with new patient medical parameter data.

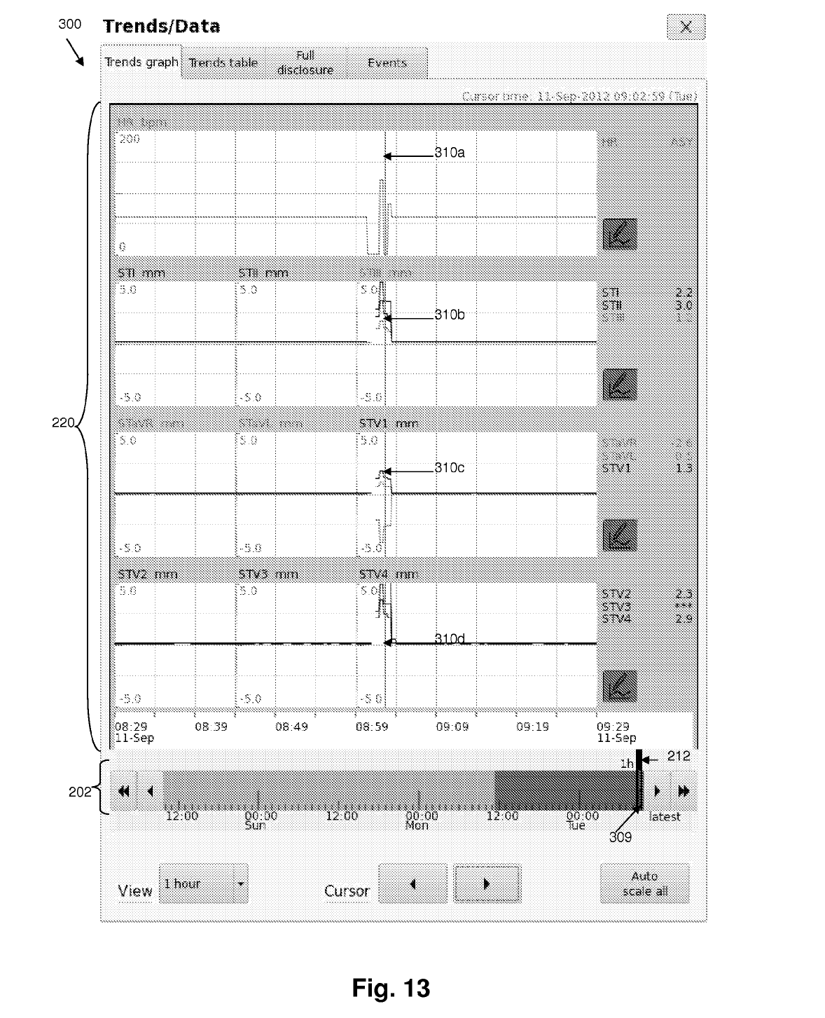

FIGS. 12-14 are exemplary screen shots of the graphical trend display image 300. As shown herein, the second visual band 212 defines a time window equal to one hour. A cursor indicator 309 is displayed within the navigation bar 202 to indicate a position of the cursor 310. As shown herein, the cursor indicator 309 is within the second visual band 212 resulting the cursor being displayed in each respective patient medical parameter data that is stored in the database and being displayed in display window 220. In this embodiment, the cursor 310 is the second type of cursor that floats. Thus, the controller 104 causes the display processor 108 to display the cursor 310 as the second type of cursor display (e.g. dashed line). As shown herein, there are four different patient medical parameters being displayed and positioned at a latest point in time are respective second types of cursors 310a-310d. This advantageously indicates that the patient parameter data is not static and the value of data at the location where the cursor is presently displayed will change when the database is updated with new patient medical parameter data. Referring now to FIG. 13, the cursor indicator 309 is positioned substantially at a center point of the window defined by the second visual band 212. The controller 104 detects the position of the cursor and determines if the cursor is one of at the earliest point in time of the window or the latest point in time of the window. If this determination is negative, the controller 104 causes the display processor 108 to display the cursor 310 as the first type of cursor having the first type of cursor display (e.g. a solid line). As shown herein, first type of cursors 310a-310d are displayed at the same position within each patient medical parameter data displayed in data display window 220. This indicates that the data at that point in the database will not change for a predetermined amount of time equal to a time between a current position of the cursor 310 and an earliest time of the window defined by the second visual band 212. FIG. 14 is another embodiment of the graphical trend display image 300 when the second visual band 212 is positioned at an earliest point in time and the cursor 310 is positioned at an earliest time of the window defined by the second visual band 212. The controller detects the position of the cursor 310 (as indicated by cursor indicator 309) and determines that the cursor 310 is at the earliest point in time within the patient parameter database and causes the display processor 108 to display the second type of cursor in the second type of cursor display (e.g. dashed line). This is represented by the dashed lines labeled 310a-310d. By displaying the second type of cursor that floats, a clinician is quickly notified that the set of data being viewed will change and that any data samples adjacent to the second type of cursor will no longer be displayed when the database updates.

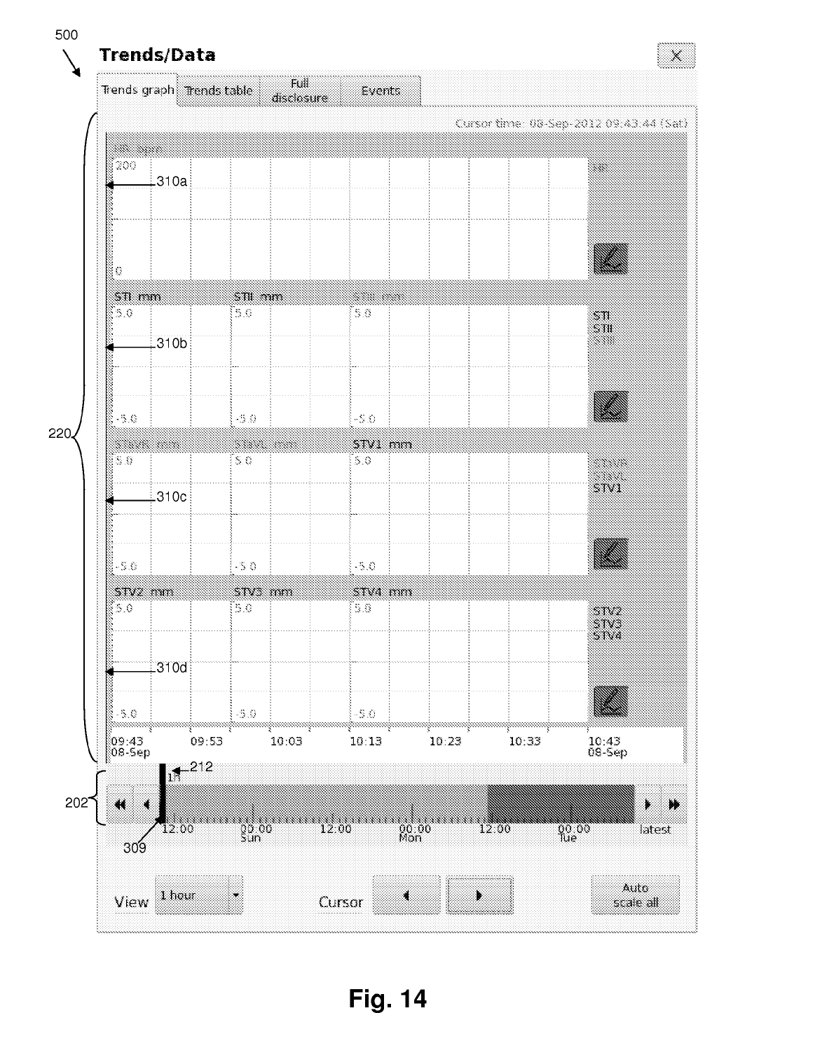

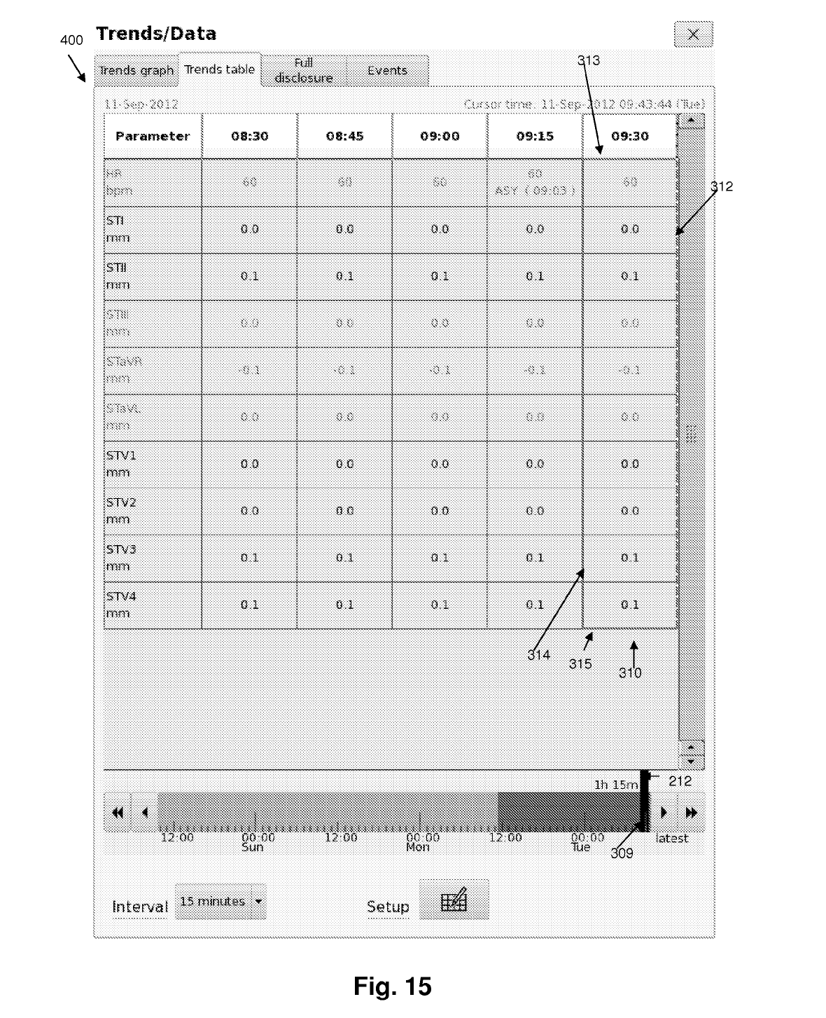

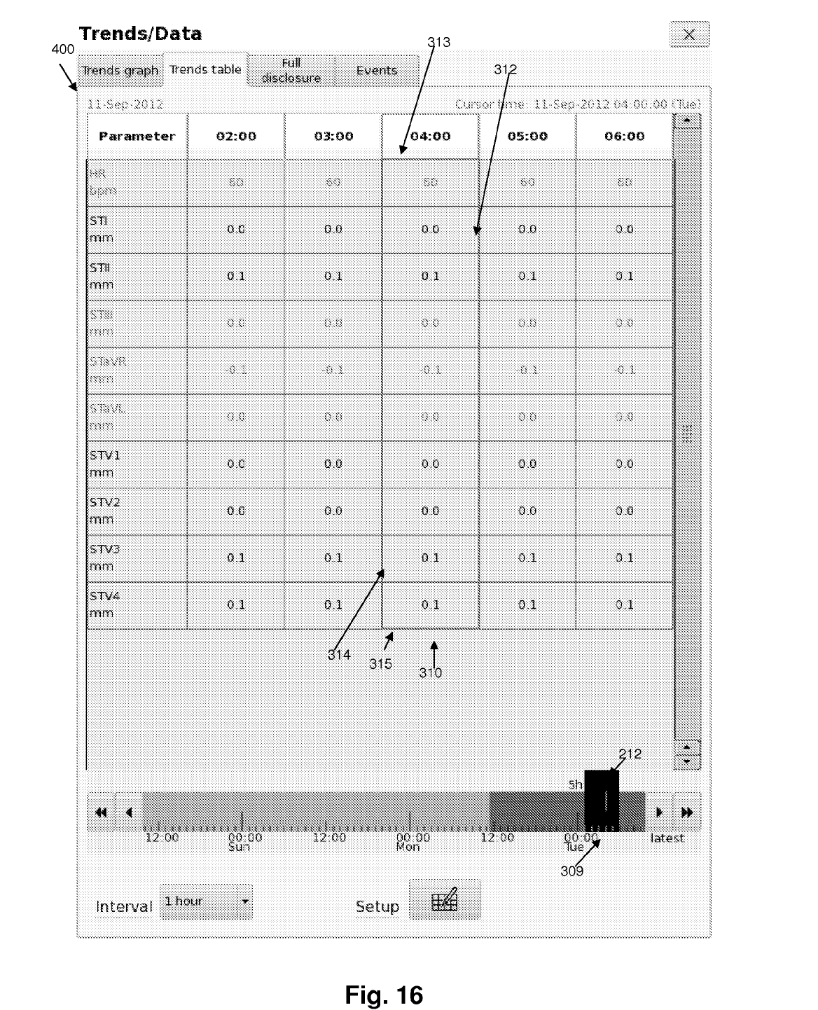

FIGS. 15-17 are screen shots of the tabular trend display image 400. Because the patient medical parameter data is being displayed in tabular form, the display processor 108 represents the cursor as a box or outline positioned around the column representing the time interval closest to the position of the cursor. In FIG. 15, the cursor indicator 309 is positioned at a latest point in time of the time window defined by the second visual band 212. In response to determining the cursor position, the controller 104 directs the display processor to display the second type of cursor having the second type of cursor display. In contrast to the single dashed lines described above in FIGS. 12-14, only a portion 312 (e.g. an edge thereof) of the cursor display closest to the latest point in time is modified to be displayed as a dashed line with the remaining portion (313, 314, 315) of the cursor 310 being displayed as solid. As used hereinafter, the term portion of the cursor refers to an edge of a cursor. However, this is described for purposes of example only and the cursor may be of any shape and size and the portion may include any part of the cursor. This advantageously indicates to a clinician that new data will be displayed when the database is updated. The screen shot of FIG. 16 has the cursor 310 being positioned within the second visual band and not at an earliest or latest point of the displayed time. The controller 104 detects the position of the cursor and determines that the cursor is not at an earliest or latest point in time of the time window and causes the display processor 108 to display the cursor 310 as the first type of cursor in the first type of cursor display. Thus, the cursor 310 is a solid line on all edges 312, 313, 314 and 315. The screen shot of FIG. 17 represents the display image 400 when the cursor 310 is positioned at an earliest point in time within the window defined by second visual band 212. Upon detecting that the cursor 310 is at the earliest point in time in the patient parameter database, the controller 104 causes the display processor 108 to modify a different edge 314 of the cursor 310 to be formatted in the second type of cursor display (e.g. dashed line) while causing the remaining edges 312, 313 and 315 to have the first type of cursor display. The modified cursor in FIG. 17 differs from the modified cursor in FIG. 15 based on the point in time such that the second type of cursor display (e.g. dashed line) is positioned at the point where new data will be added upon update of the database as shown in FIG. 15 or where old data will no longer be displayed upon update of the database as shown in FIG. 17.

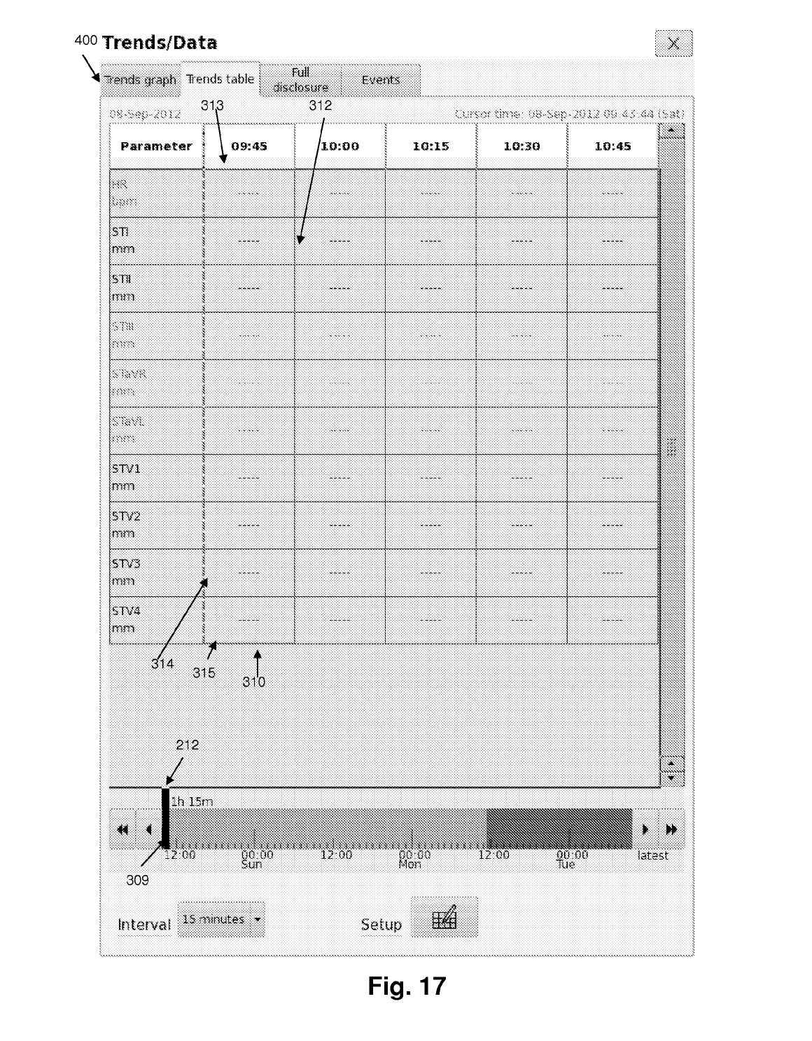

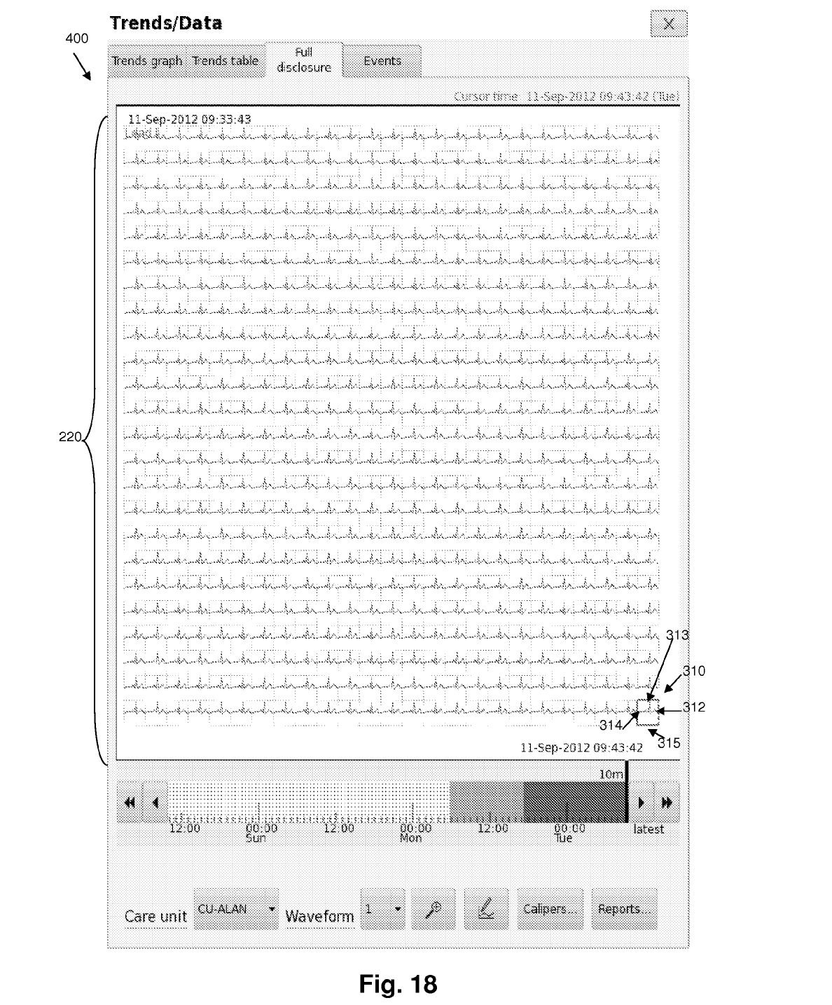

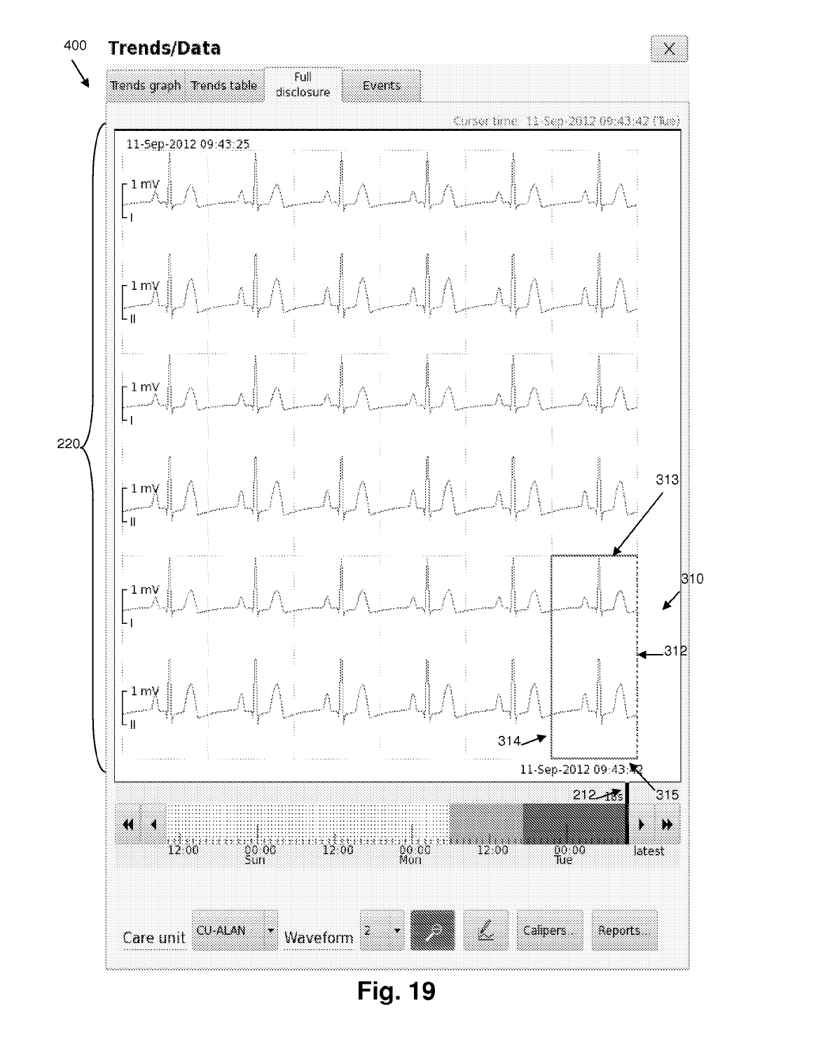

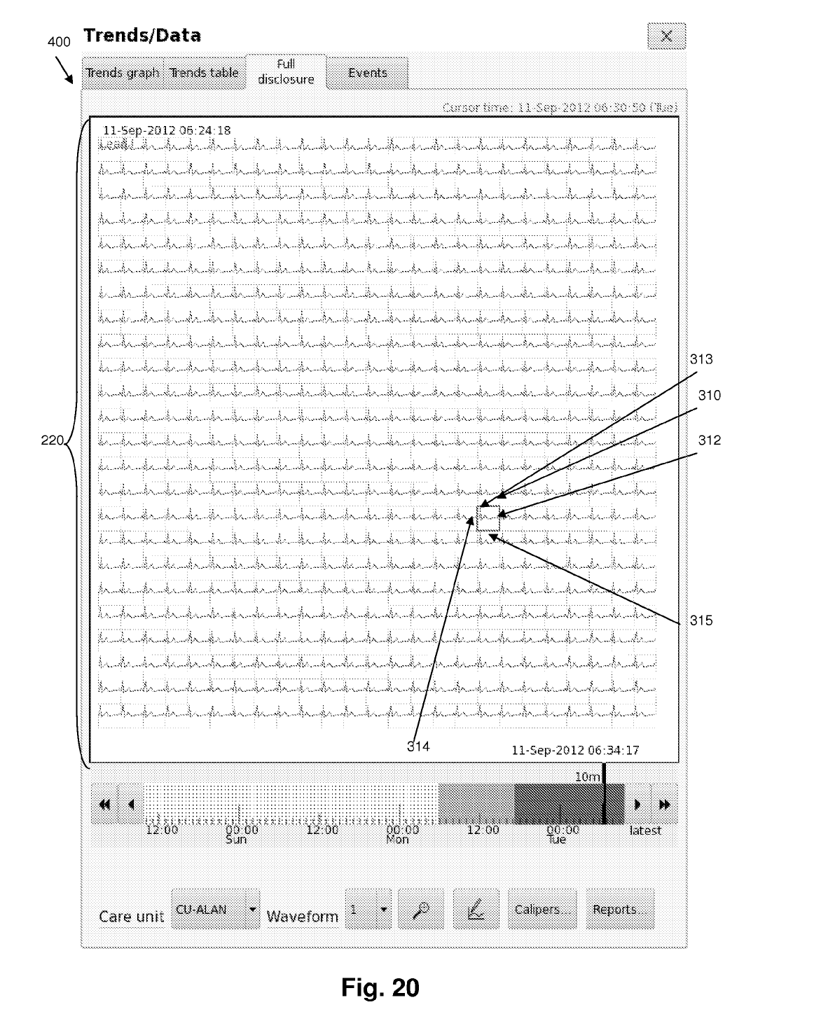

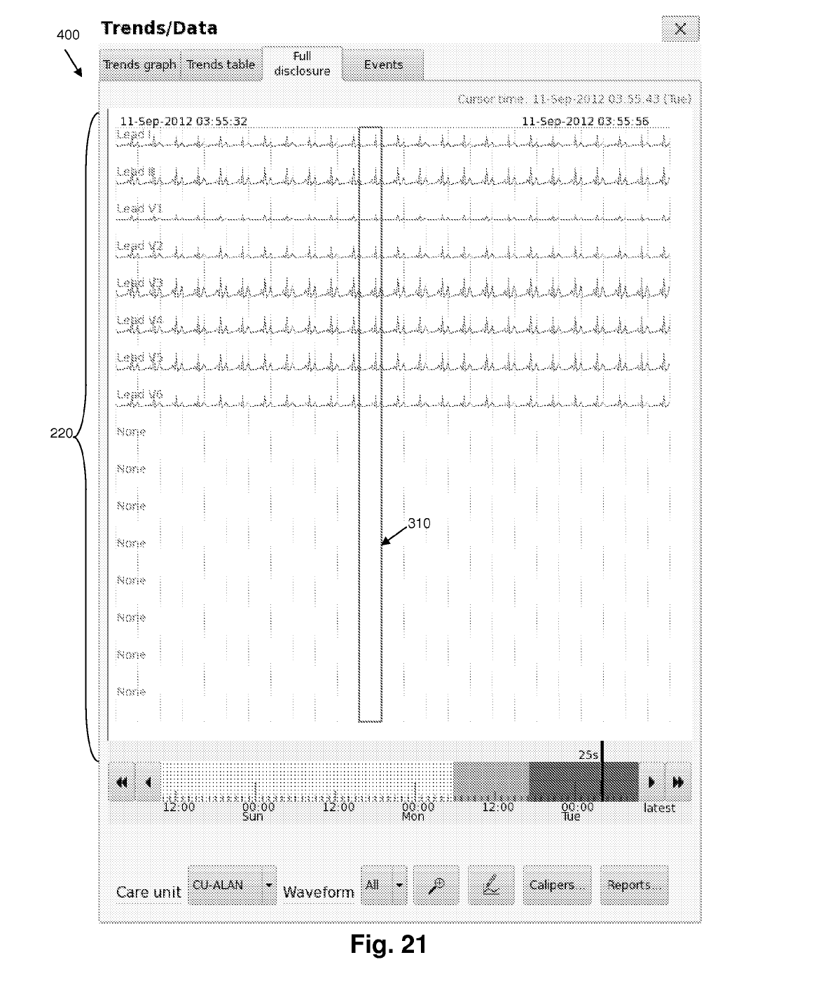

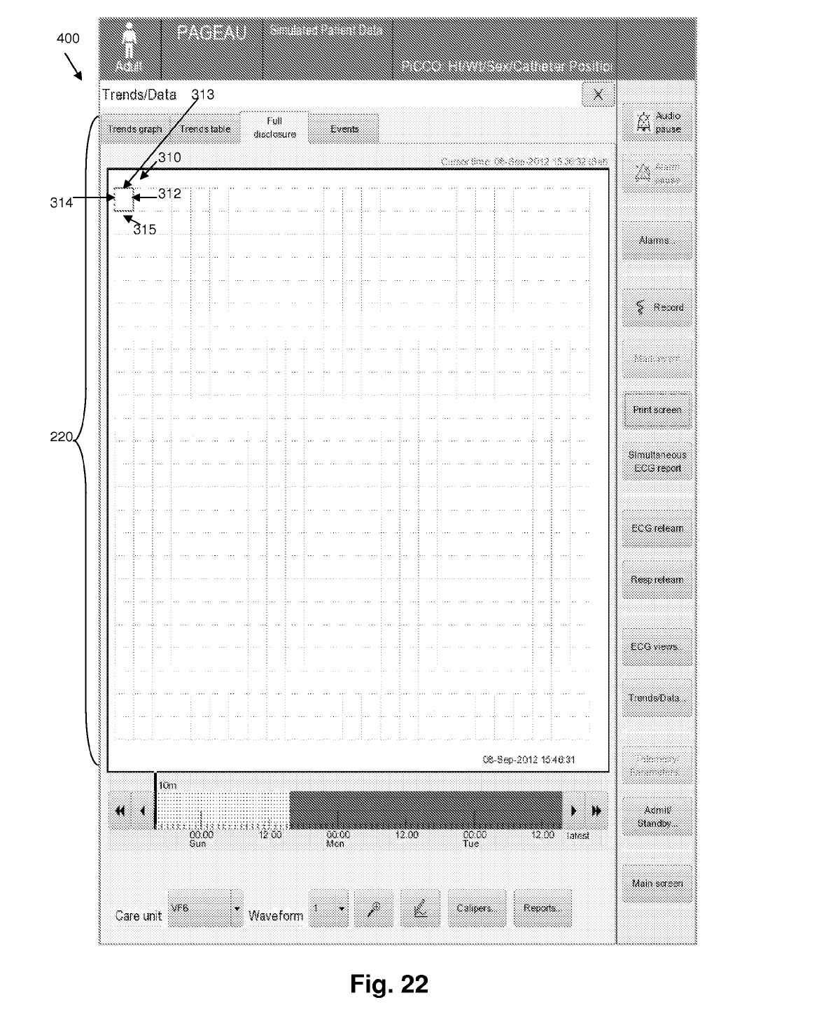

FIGS. 18-22 are exemplary screen shots of various full disclosure display images 500. In FIG. 18, raw data associated with a respective patient medical parameter is displayed within data display window 220. The cursor 310 is positioned at a latest point in time and selects the most recently added data sample. In this embodiment, the display processor 108 causes the cursor 310 to surround the particularly selected data sample such that the cursor has four edges 312, 313, 314 and 315. The controller 104 detects the position of the cursor 310 and determines that the cursor 310 is positioned at the latest point in time and thus is a second type of cursor (e.g. floating cursor). The controller 104 directs the display processor 108 to modify one of the edges 312 to be displayed in the second type of cursor display (e.g. dashed line) indicating that, upon database update, a new data sample will be selected by the cursor 310. In one embodiment, if the cursor 310 floats, upon introduction of a new data sample, the display processor 108 may automatically modify the edge 312 of the cursor to be displayed in a same manner as edges 313, 314 and 315 thereof. FIG. 19 is a screen shot a of set of patient medical parameter data wherein the second visual band 212 defines a window of time smaller than the window of time defined in FIG. 18. The result is a larger and more detailed display of patient medical parameter data in data display window 220. FIG. 19 also shows how the cursor 310 is displayed when positioned at the latest point in time of the window defined by the second visual band 212. The cursor 310 surrounds the selected data samples and, in response to the controller 104 determining that the position of the cursor is at the latest point in time of the time window, the display processor 108 causes the cursor 310 to be displayed as the second type of cursor wherein a first edge 312 is displayed in a visually different manner (e.g. dashed lines) as compared to the other edges 313, 314 and 315 of the cursor (e.g. solid lines). The display image 500 in FIG. 20 shows the cursor 310 being positioned at a point in the time window that is neither the earliest nor the latest point in time. The controller 104 detects the position of the cursor 310 and, in response to determining that the cursor is within the window but not at the earliest or latest point in time, directs the display processor 108 to display the cursor 510 as the first type of cursor wherein each edge thereof is displayed in the same visual manner (e.g. solid lines). FIG. 21 is an exemplary embodiment of a full disclosure display image 400 that is displaying all of the different types of patient medical parameter data that is present within the window defined by the second visual band 212. The cursor 310 is positioned to surround the selected patient medical parameters at the particular point within the window. The controller 104 is able to determine the position of the cursor 310 as being within the time window but not at the earliest or latest point in time and the display processor 108 causes the cursor 310 to be displayed as the first type of cursor wherein all edges 312, 313, 314 and 315 are displayed in the same visual manner (e.g. solid lines). If the controller 104 determined that the cursor was either at the earliest or latest time within the window, the display processor 108 would display the cursor 310 as the second type of cursor and cause a respective edge thereof to be displayed in a visually distinct manner as compared to the other edges as shown in FIGS. 18, 19 and FIG. 22. The term visually distinct may refer to any type of processing or formatting that causes one edge to appear different than any other edge. This may include, but is not limited to line formatting (e.g. dashed or other patterned lines versus solid lines, different colors, variations in shading, bold versus not bold, etc). The full disclosure display image 400 shown in FIG. 22 shows the cursor being positioned at an earliest time point within the window defined by the second visual band 212. The controller 104, in response to determining that the cursor 310 is at the earliest point in time, causes the display processor 108 to display the cursor as the second type of cursor wherein one edge 314 is displayed in a visually different manner than the other edges 312, 313, 315 of the cursor 310. This indicates that any data within the cursor 310 will no longer be displayed when the database updates with new patient medical parameter data. Moreover, the display image 500 in FIG. 22 does not include any patient medical parameter data in data display window 220 because the second visual band 212 is positioned within a region 204a of the navigation bar 202 within which no patient medical parameter data currently exists or will ever exist.

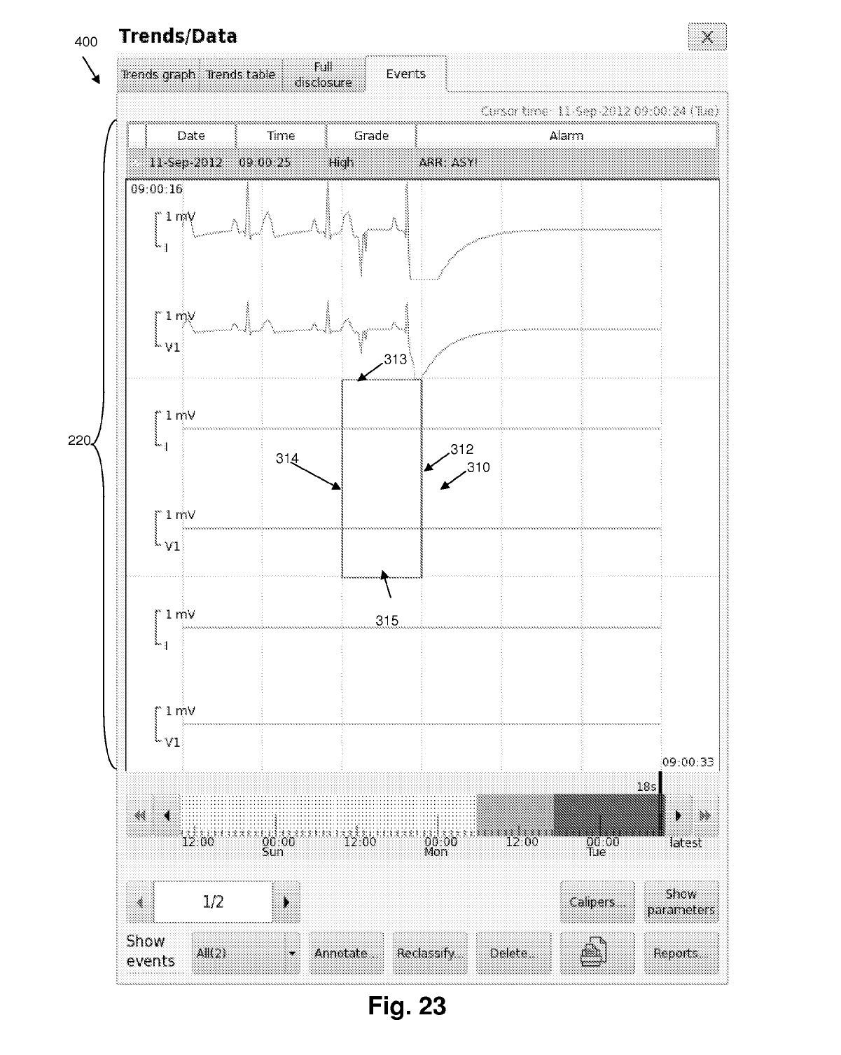

FIG. 23 is an event display image 600 that displays patient parameter data associated with a clinically significant event. The cursor 310 operates in a similar manner as discussed above with respects to FIGS. 18-22. As shown herein, the cursor is positioned within the time window but not at an earliest or latest point in time. Thus, the controller 104 detects the position and the display processor 108 causes the cursor 310 to be displayed as the first type of cursor having the first type of cursor display (e.g. solid line along all edges 312, 313, 314 and 315 thereof).

A further advantageous feature of the system according to invention principles is the ability to display an event indicator both within the navigation bar 202 as well as within a respective one of the types of display images such as the tabular trend display image 400. In the tabular trend display image 400, the controller 104 causes the patient medical parameter data to be displayed numerically providing a summary of the particular parameter at respective intervals within the window of time defined by the second visual band 212. In response to determining that an event associated with a particular type of patient parameter data occurred at a time between the previous interval and the current interval, the controller 104 causes a second event indicator to be displayed in the same data field as the particular patient parameter data of the current interval. This advantageously insures that the clinician will be notified about the event by looking at the patient medical parameter data in the most recent time interval. Moreover, the second event indicator may include at least one type of context data that identifies one of (a) a type of event; (b) an actual time of event occurrence; (c) data describing the event; and (d) a severity indicator indicating the severity of the event. These types of context data are described for purposes of example only and any type of data that provides any description of or information about the event may be included as part of the second event indicator.

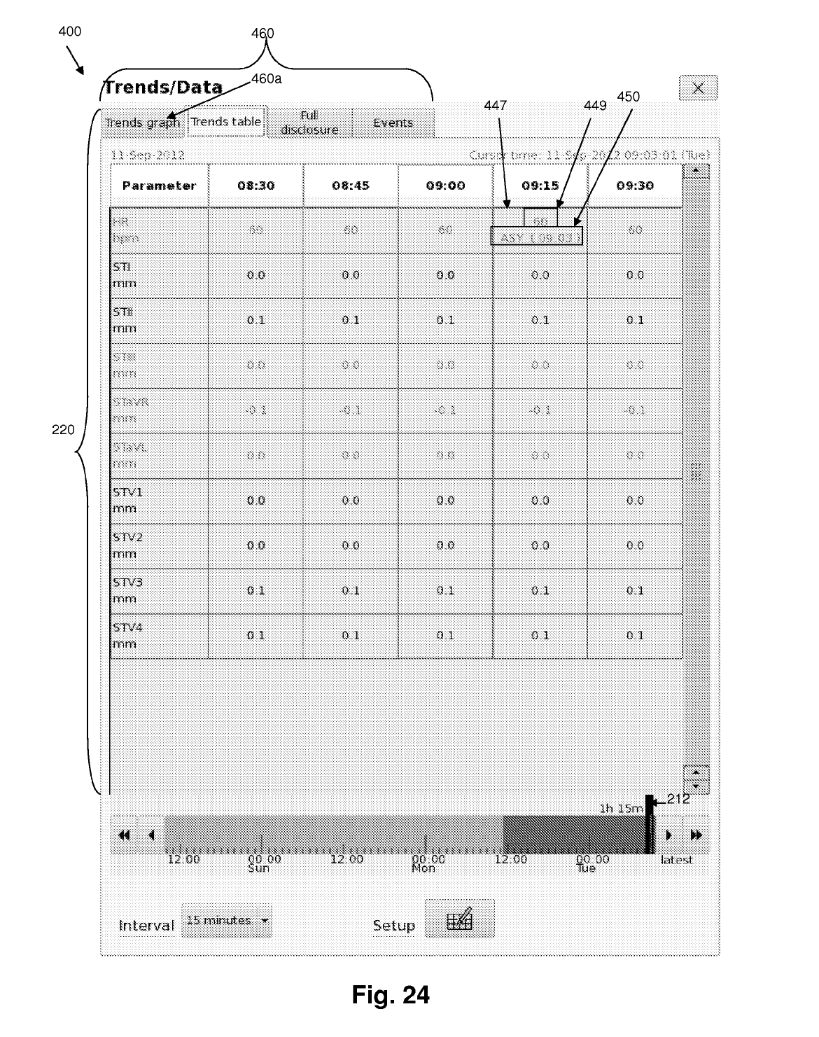

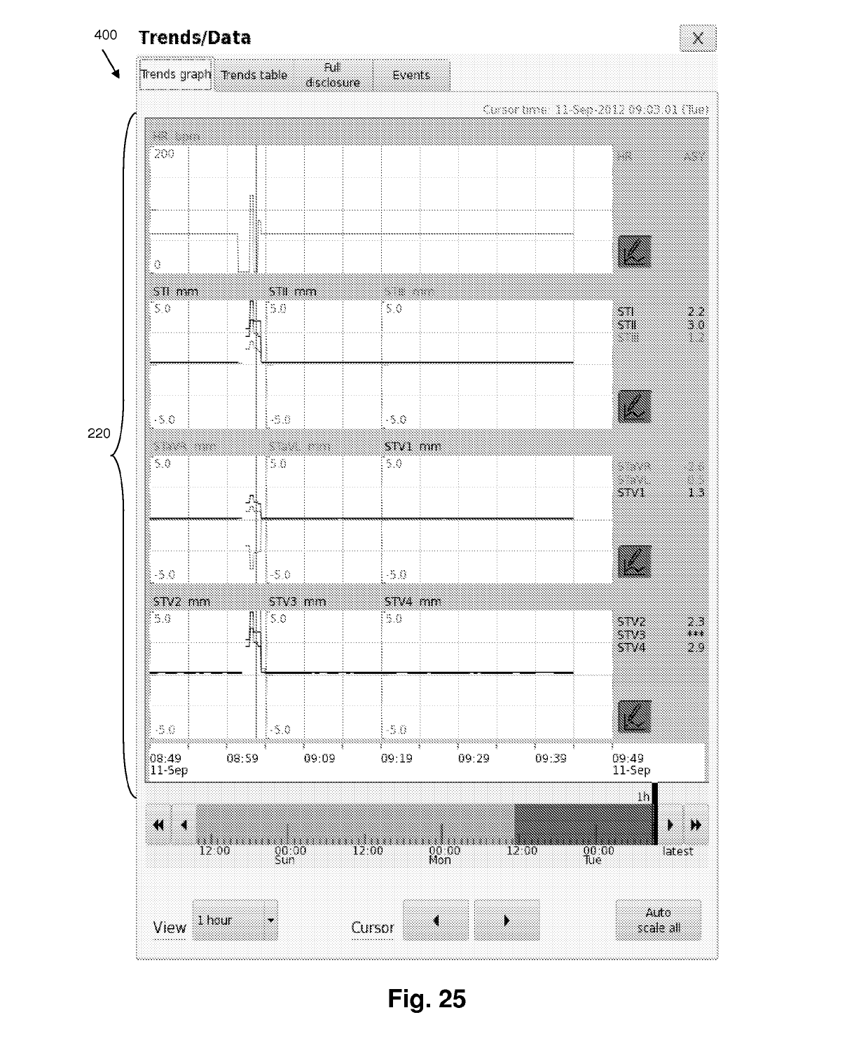

FIGS. 24 and 25 are screen shots showing the advantages of the second event indicator being displayed to a clinician. In FIG. 24, a tabular trend display image 400 is provided. The patient medical parameter data is being displayed in 15 minute intervals over a time period of one hour (as determined by the second visual band 212). A clinically significant event has occurred after the “9:00” interval but prior to the “9:15” interval. For example, the clinically significant event is an occurrence of asystole which is related to the patient medical parameter of “heart rate” as shown in the first row 445. Thus, the controller causes the second event indicator 450 to be displayed in a data field 447 that corresponds to the “9:15” interval in the first row 445. The second event indicator 450 is displayed simultaneously with patient medical parameter data 449. Therefore, despite the event occurring in an interval prior to “9:15”, the second event indicator 450 is present in the next interval to insure that the clinician is aware of the event. By presenting the second event indicator 450 in the later interval, the clinician can quickly discern that the event occurred and selectively switch display images by selecting a respective one of tabs 460 in display image 400. For example, the clinician may select the graphical trend tab 460a to display a graphical trend of patient parameter data associated with the event. Moreover, because the event is within the window defined by the second visual band 212, the position in the database is maintained and the controller 104 causes the display processor 108 to display the graphical trend data within the defined window. The result of this action is shown in FIG. 25 whereby patient parameter data associated with the event is displayed within data display window 220.

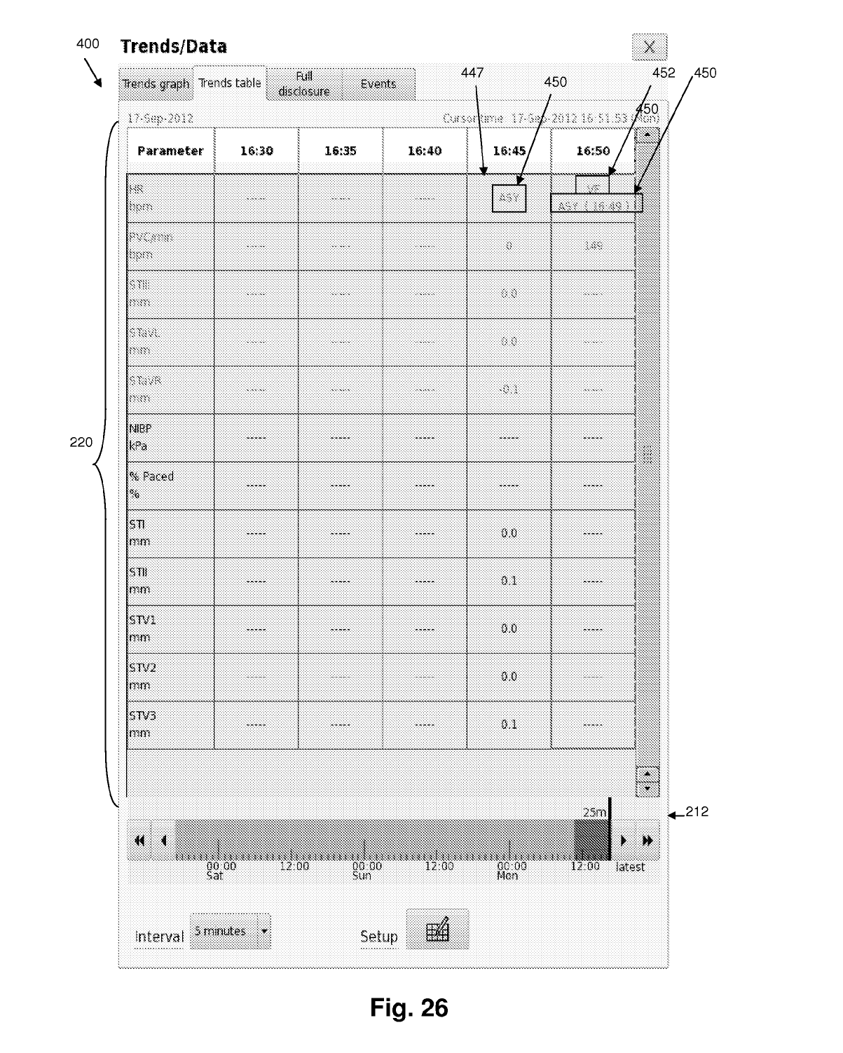

In addition to being able to display a current patient parameter in conjunction with a clinically significant event in a single data field as shown in FIG. 24, the system 100 is further able to advantageously generate a user interface display image that provides information associated with multiple clinically significant events in a single data field. An exemplary screen shot of a user interface display image 400 generated by display processor 108 including a data field 451 indicating multiple clinically significant events is shown in FIG. 26. In FIG. 26, the display image 400 includes a trend table displayed in data display window 220. The trend table is a tabular representation of the time window defined by the second visual band 212 (e.g. 25 minutes) at the intervals defined by the interval selector 420 (e.g. 5 minute intervals). Based on the time window and intervals of the embodiment shown in FIG. 26, the display image 400 includes five columns representing the respective intervals. Additionally, the display image 400 includes a number of selected rows less than or equal to a maximum number of different patient medical parameters acquired by the acquisition processor 106. As shown herein, there are twelve rows indicative of different patient medical parameters associated with the patient. Row 1 is indicative of the heart rate of the patient. The tabular trend display image 400 shows the data field 447 in the column labeled “16:45” including a second event indicator 450 indicating that, at some point between the immediately preceding interval “16:40” and the interval “16:45” the clinically significant event of asystole occurred. At the next (present) measured interval “16:50”, the display processor 108 automatically updates the data field 451 to indicate a clinically significant event that is occurring at the present interval of “16:50”. In this embodiment, where the further clinically significant event, ventricular fibrillation (VF), occurred at the current interval, the display processor 108 generates a current event indicator 452 for display in data field 451. The current event indicator 452 is displayed above an event indicator 450 which indicates that a clinically significant event occurred after the previous interval “16:45” but prior to the current interval “16:50”. As shown herein, the prior occurring clinically significant event is asystole. Additionally, either or both of the current event indicator 452 or the second event indicator may include associated context data providing the clinician with additional information associated with the respective clinically significant event displayed therein. The second event indicator 450 includes context information representing a time stamp indicating a time at which the clinically significant event of asystole occurred. While the modification in displays are discussed for the first row only, it should be understood that any of a current event indicator 452 and second event indicator 450 may be displayed in any row associated with any patient medical parameter in response to the controller 104 determining that a clinically significant event has occurred or is occurring. The controller 104 automatically analyzes the acquired patient medical parameter data and displays, in the data field 451, a second event indicator 450 based on a priority level associated with the respective clinically significant event being displayed. Thus, a predetermined number of second event indicators 450 may be displayed within a respective data field 451 in an order of highest priority such that, immediately below the current event indicator 452 are the at least one second event indicator 450 displayed in a descending order from highest priority to lowest priority. The controller 104 automatically analyzes and provides updated patient medical parameter data in response to database updates resulting in the display processor 108 generating new user interface display images including any and all relevant data representative of clinically significant events therein.

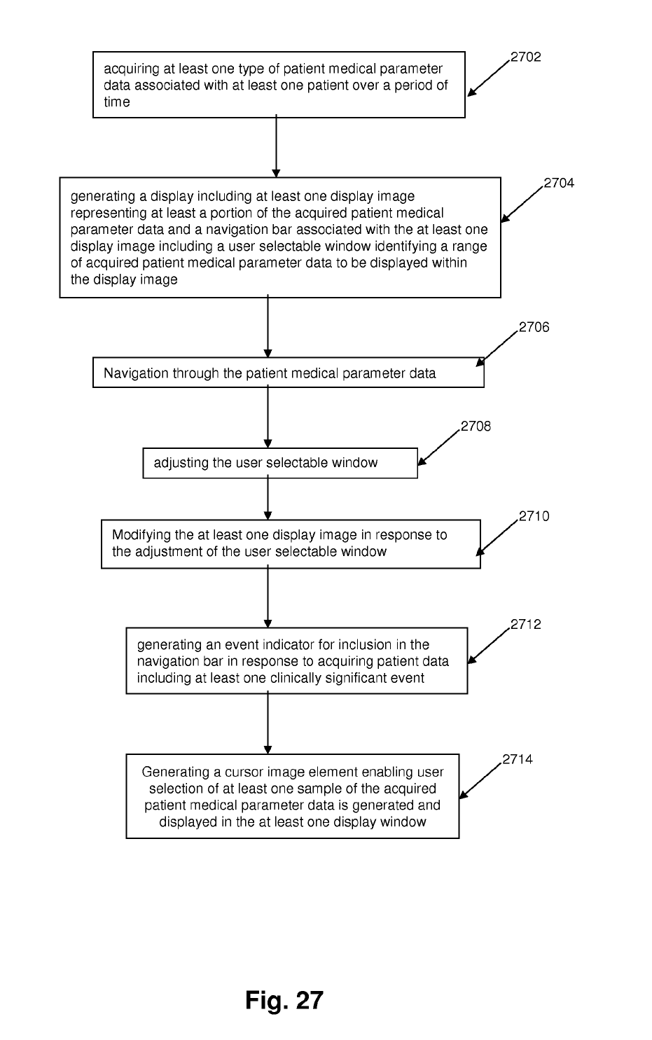

A flow diagram detailing an algorithm used in generating the various user interface display images described above with respect to FIGS. 2-26 is provided in FIG. 27. In step 2702, at least one type of patient medical parameter data associated with at least one patient acquired over a period of time is acquired from a repository via an acquisition processor. A display processor generates a display (including, but not limited to, at least one of (a) a graphical trend display image and (b) a tabular trend display image). The display includes at least one display image representing at least a portion of the acquired patient medical parameter data and a navigation bar associated with the at least one display image including a user selectable window identifying a range of acquired patient medical parameter data to be displayed within the display image in step 2704. In one embodiment, the generation of the at least one display image is performed using formatting data that is at least one of (a) acquired with the patient medical parameter data from the repository; (b) acquired from a patient monitoring device connected to a particular patient; and (c) generated formatting data by a user of the apparatus. In the embodiment where the formatting data is generated, the apparatus may generate a formatting configuration display image enabling user selection of at least one type of patient medical parameter data included in the at least one display image and an order in which the selected at least one type of patient medical parameter data is displayed within the at least one display image.

Navigation through the patient medical parameter data is performed by a controller in step 2706 such that the user selectable window may be adjusted in step 2708 and the at least one display image may be modified in step 2710 in response to navigation through the display image.

In one embodiment, the navigation in step 2706 may include navigating through patient medical parameter data by moving the user selectable window along the navigation bar to modify a period of acquired patient medical parameter data being displayed and the modification of the generated at least one display image in step 2710 includes updating patient medical parameter data corresponding to the modified period. In another embodiment, the adjustment of the user selectable window in step 2708 may include at least one of (a) increasing the range of the user selectable window and (b) decreasing the range of the user selectable window by the controller in response to user selection.

In response the acquisition of patient medical parameter data including data representing at least one clinically significant event, the display processor generates an event indicator for inclusion in the navigation bar, the event indicator corresponding to at least one clinically significant event in the acquired patient medical parameter data in step 2712. In one embodiment, the apparatus may detect user input at a position within the navigation bar within a predefined range surrounding the event indicator resulting in the modification of the at least one display image to include the acquired patient medical parameter data associated with the at least one clinically significant event. In another embodiment, in response to the user selection, the user selectable window may be automatically moved to include the event indicator. In a further embodiment, the user selectable window may be moved to a position having the event indicator at substantially a center time thereof.

In step 2714, a cursor image element enabling user selection of at least one sample of the acquired patient medical parameter data is generated and displayed in the at least one display window, the cursor image element being associated with one of (a) a selected position within the at least one display image; and (b) a selected data sample of the acquired patient medical parameter data. In one embodiment, at least one boundary of the cursor image element associated with a selected position in the at least one display image is modified to be visually distinct indicating the acquired patient medical parameter data selected by the cursor image element will change upon acquisition of additional patient medical parameter data. In another embodiment, the cursor image element associated with the selected data sample is caused to move with the selected data sample within the at least one display image upon acquisition of additional patient medical parameter data.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

1. An apparatus that displays at least one user interface display image including patient parameter data, the apparatus comprising:
an acquisition processor that selectively acquires, from a storage repository, at least one type of patient medical parameter data associated with at least one patient acquired over a period of time;
a display processor that generates a display including at least one display image representing at least a portion of the acquired patient medical parameter data and a navigation bar associated with the at least one display image including a user selectable window identifying a range of acquired patient medical parameter data to be displayed within the display image, the user selectable window being linked with the at least one display image, the navigation bar including an event indicator corresponding to at least one clinically significant event in the acquired patient medical parameter data; and
a controller electrically coupled to the acquisition processor and the display processor that, controls navigating through the patient medical parameter data and adjustment of the user selectable window, and causes the display processor to modify the generated at least one display image.

2. The apparatus as recited in claim 1, wherein
the controller enables navigation through patient medical parameter data by moving the user selectable window along the navigation bar to modify a period of acquired patient medical parameter data being displayed and controls the display processor to modify the generated at least one display image to include updated patient medical parameter data corresponding to the modified period.

3. The apparatus as recited in claim 1, wherein
the range of the user selectable window is one of (a) increased; or (b)
decreased by the controller in response to user selection.

4. (canceled)

5. The apparatus as recited in claim 1, wherein
the controller causes the display processor to modify the at least one
display image to include the acquired patient medical parameter data associated with the at least one clinically significant event in response to detecting user input at a position within the navigation bar within a predefined range surrounding the event indicator.

6. The apparatus as recited in claim 5, wherein
the controller causes the display processor to move the user selectable
window to include the event indicator therein in response to the user selection.

7. The apparatus as recited in claim 6, wherein
the user selectable window is automatically moved to a position having the event indicator at substantially a center time thereof.

8. The apparatus as recited in claim 1, wherein
the portion of the acquired patient medical parameter data is at least one of (a) a graphical trend display image; and (b) a tabular trend display image.

9-15. (canceled)

16. The apparatus as recited in claim 1, wherein
the navigation bar generated by the display processor includes at least one of
(a) a first region representing a first time period and having a first visual format, the first visual format indicating patient medical parameter data is present during the first time period;
(b) a second region representing a second time period different from the first time period and having a second visual format, the second visual format indicating that patient medical parameter data has not yet been received during the second time period; and
(c) a third region representing a third time period different from the first and second time periods and having a third visual format, the third visual format indicating that patient medical parameter data will never be present during the third time period.

17. The apparatus as recited in claim 1, wherein
the at least one display image includes a plurality of data fields each corresponding to an interval of the range acquired patient medical parameter data identified by the user selectable window, and
said display processor generates an event indicator within a current interval data field upon said controller determining that a clinically significant event has occurred at a time between a current interval and a previous interval, the event indicator being simultaneously displayed in the current interval data field with a current patient medical parameter value.

18. The apparatus as recited in claim 17, wherein
the event indicator in the current interval data field is visually distinct from the current patient medical parameter.

19. The apparatus as recited in claim 17, wherein
the event indicator includes context data that identifies at least one of that identifies at least one of (a) a type of event; (b) an actual time of event occurrence; (c) data describing the event; and (d) a severity indicator indicating the severity of the event.

20. A method of generating at least one user interface display image including patient parameter data comprising the activities of:
acquiring from a storage repository, via an acquisition processor, at least one type of patient medical parameter data associated with at least one patient acquired over a period of time;
generating, via a display processor, a display including at least one display image representing at least a portion of the acquired patient medical parameter data and a navigation bar associated with the at least one display image including a user selectable window identifying a range of acquired patient medical parameter data to be displayed within the display image, the user selectable window being linked with the at least one display image;
generating, by the display processor, an event indicator for inclusion in the navigation bar, the event indicator corresponding to at least one clinically significant event in the acquired patient medical parameter data; and
controlling, via a controller, navigating through the patient medical parameter data and adjusting the user selectable window, and causing the display processor to modify the generated at least one display image.

21. The method as recited in claim 20, wherein the activity of controlling further includes
navigating through patient medical parameter data by moving the user selectable window along the navigation bar to modify a period of acquired patient medical parameter data being displayed; and
modifying the generated at least one display image to include updated patient medical parameter data corresponding to the modified period.

22. The method as recited in claim 20, further comprising
at least one of (a) increasing the range of the user selectable window
and (b) decreasing the range of the user selectable window by the controller in response to user selection.

23. (canceled)

24. The method as recited in claim 20, further comprising the activity of
detecting user input at a position within the navigation bar within a predefined range surrounding the event indicator; and
modifying, the at least one display image to include the acquired patient medical parameter data associated with the at least one clinically significant event.

25. The method as recited in claim 24, further comprising
moving the user selectable window to include the event indicator therein in response to the user selection.

26. The method as recited in claim 25, wherein the activity of moving further comprises
moving the user selectable window to a position having the event indicator at substantially a center time thereof.

27. The method as recited in claim 20, wherein the activity of generating the at least one display image includes
at least one of (a) generating a graphical trend display image; and (b) generating a tabular trend display image.

28.-31. (canceled)

32. The method as recited in claim 20, wherein the activity of generating the navigation bar includes at least one of
(a) defining a first region representing a first time period having a first visual format, the first visual format indicating patient medical parameter data is present during the first time period;
(b) defining a second region representing a second time period different from the first time period having a second visual format, the second visual format indicating that patient medical parameter data has not yet been received during the second time period; and
(c) defining a third region representing a third time period different from the first and second time periods having a third visual format, the third visual format indicating that patient medical parameter data will never be present during the third time period.

33. The method as recited in claim 20, wherein
the at least one display image includes a plurality of data fields each corresponding to an interval of the range acquired patient medical parameter data identified by the user selectable window, and further comprises
generating an event indicator within a current interval data field upon said controller determining that a clinically significant event has occurred at a time between a current interval and a previous interval, the event indicator being simultaneously displayed in the current interval data field with a current patient medical parameter value.

34.-35. (canceled)
